(19) United States
(12) Patent Application Publication
(10) Pub. No.: US 2026/0119866 A1
(43) Pub. Date: Apr. 30, 2026

(54) MODEL TRAINING METHOD AND APPARATUS

(71) Applicant: MASHANG CONSUMER FINANCE CO., LTD., Chongqing (CN)

(72) Inventors: Qizhu DAI, Chongqing (CN); Kuan LI, Chongqing (CN); Lebin LV, Chongqing (CN); Wenjun CHEN, Chongqing (CN); Chuanqi LIU, Chongqing (CN)

(73) Assignee: MASHANG CONSUMER FINANCE CO., LTD., Chongqing (CN)

(21) Appl. No.: 19/196,667

(22) Filed: May 1, 2025

(30) Foreign Application Priority Data
Oct. 28, 2024 (CN) 202411515978.1

(51) Int. Cl. G06N 3/08; G06N 3/047

(52) U.S. Cl. CPC G06N 3/08; G06N 3/047

(57) ABSTRACT

In a model training method, feature extraction is performed on a plurality of words in a first training sample to obtain first feature vectors of the plurality of words, the first training sample including at least a first part of training samples for pre-training a first model. Relation classification is performed to obtain a first classification probability of the first training sample. A plurality of sample-relation pairs formed by the first training sample and each relation of a plurality of second relations are determined. Similarity calculation is performed to obtain similarities corresponding to the sample-relation pairs. A first weight of a sample-relation pair is determined. A first loss of the first model is determined based on the first weight of the sample-relation pair and the first classification probability. A parameter of the first model is adjusted based on the first loss.

### RELATED APPLICATION

The present application claims priority to Chinese Patent Application No. 202411515978.1 filed on Oct. 28, 2024, which is hereby incorporated by reference in its entirety.

### TECHNICAL FIELD

This disclosure relates to the field of artificial intelligence technologies, including to a model training method and apparatus, a classification method and apparatus, a computer device, and a storage medium.

### BACKGROUND

Relation extraction (RE) is an important component in the field of natural language processing and data analysis, and focuses on identifying and classifying a semantic relation between entities in a text.

Relation extraction has wide application prospects in daily life, such as information retrieval, knowledge base construction, sentiment analysis, financial consumption data interpretation, and so on. Relation extraction is crucial for understanding the structure and meaning of language.

### SUMMARY

Aspects of this disclosure provide a model training method and apparatus, a classification method and apparatus, a computer device, and a storage medium.

According to an aspect of this disclosure, a model training method is provided. In the method, feature extraction is performed on a plurality of words in a first training sample to obtain first feature vectors of the plurality of words, the first training sample including at least a first part of training samples for pre-training a first model. The plurality of words of the first training sample having one or more first relations. Relation classification is performed on the plurality of words based on the first feature vectors, to obtain a first classification probability of the first training sample. A plurality of sample-relation pairs formed by the first training sample and each relation of a plurality of second relations are determined. The second relations include at least a part of the one or more first relations. Similarity calculation is performed on the first feature vectors of the plurality of words of the first training sample in the sample-relation pairs and second feature vectors of the plurality of second relations, to obtain similarities corresponding to the sample-relation pairs. A first weight of a sample-relation pair of the plurality of sample-relation pairs is determined based on the similarity corresponding to the sample-relation pair, the first classification probability of the first training sample, and the first relation. A first loss of the first model is determined based on the first weight of the sample-relation pair and the first classification probability. A parameter of the first model is adjusted based on the first loss.

According to an aspect of this disclosure a classification method is provided. In the method, a to-be-recognized text including a plurality of entity words is obtained. Feature extraction is performed on the plurality of entity words in the to-be-recognized text by using a first model, to obtain feature vectors of the entity words. Relation classification is performed on the entity words based on the feature vectors by using the first model, to obtain a classification probability of the to-be-recognized text. A relation between the entity words in the to-be-recognized text is determined based on the classification probability.

According to an aspect of this disclosure a model training apparatus including processing circuitry is provided. The processing circuitry is configured to perform feature extraction on a plurality of words in a first training sample to obtain first feature vectors of the plurality of words, the first training sample including at least a first part of training samples for pre-training a first model, and the plurality of words of the first training sample have one or more first relations. The processing circuitry is configured to perform relation classification on the plurality of words based on the first feature vectors, to obtain a first classification probability of the first training sample. The processing circuitry is configured to determine a plurality of sample-relation pairs formed by the first training sample and each relation of a plurality of second relations, the second relations include at least a part of the one or more first relations. The processing circuitry is configured to perform similarity calculation on the first feature vectors of the plurality of words of the first training sample in the sample-relation pairs and second feature vectors of the plurality of second relations, to obtain similarities corresponding to the sample-relation pairs. The processing circuitry is configured to determine a first weight of a sample-relation pair of the plurality of sample-relation pairs based on the similarity corresponding to the sample-relation pair, the first classification probability of the first training sample, and the first relation. The processing circuitry is configured to determine a first loss of the first model based on the first weight of the sample-relation pair and the first classification probability. The processing circuitry is configured to adjust a parameter of the first model based on the first loss.

According to an aspect of this disclosure further provides a classification apparatus, including a text obtaining unit, a second feature extraction unit, a second classification unit, and a relation determining unit. The text obtaining unit is configured to obtain a to-be-recognized text including a plurality of entity words. The second feature extraction unit is configured to perform feature extraction on the plurality of entity words in the to-be-recognized text by using a first model, to obtain feature vectors of the entity words. The second classification unit is configured to perform relation classification on the entity words based on the feature vectors by using the first model, to obtain a classification probability of the to-be-recognized text. Thea relation determining unit is configured to determine a relation between the entity words in the to-be-recognized text based on the classification probability.

According to an aspect of this disclosure further provides a computer device, including a non-transitory memory storing a plurality of instructions; and the processor loads the instructions from the memory, to perform the steps of any model training method provided in the aspects of this disclosure.

According to an aspect of this disclosure further provides a non-transitory computer readable storage medium, where the non-transitory computer readable storage medium stores a plurality of instructions when executed by a processor cause the processor to perform the model training methods provided in this disclosure.

According to an aspect of this disclosure further provides a computer program product, including a computer program or instructions, the computer program or instructions, when executed by a processor, implementing the steps in any model training method provided in the embodiments of this disclosure.

According to some examples of this disclosure, feature extraction may be performed on a plurality of entity words in a first training sample by using a first model, to obtain first feature vectors of the entity words, the first training sample including at least a part of training samples for pre-training the first model, and the plurality of entity words of the first training sample having a first relation. Relation classification on the entity words is performed based on the first feature vectors, to obtain a first classification probability of the first training sample. Sample-relation pairs separately formed by each first training sample and a plurality of second relations is determined, the second relation including at least a part of first relations corresponding to the training samples for pre-training the first model. Similarity calculation is performed on the first feature vectors of the entity words of the first training sample in the sample-relation pair and a second feature vector of the second relation, to obtain a similarity corresponding to the sample-relation pair. A first weight of the sample-relation pair is determined based on the similarity corresponding to the sample-relation pair, the first classification probability of the first training sample in the sample-relation pair, and the first relation. A first loss of the first model is determined based on the first weight of the sample-relation pair and the first classification probability of the first training sample in the sample-relation pair, and a parameter of the first model is adjusted based on the first loss. Therefore, the sample-relation pair is assigned the first weight to calculate the loss, to adjust the model parameter, so that the model can pay more attention to similar relations, thereby helping ensure that the model distinguishes between the similar relations.

### BRIEF DESCRIPTION OF THE DRAWINGS

FIG. 1 is a schematic diagram of an example of a model training method according to an aspect of this disclosure;

FIG. 2 is a schematic diagram of an example of a model training method according to an aspect of this disclosure;

FIG. 3 is a schematic diagram of an example of a model training method according to an aspect of this disclosure;

FIG. 4 is a schematic flowchart of a model training method according to an aspect of this disclosure;

FIG. 5 is a schematic flowchart of replay training of a first model according to an aspect of this disclosure;

FIG. 6 is another schematic flowchart of a training method for a first model according to an aspect of this disclosure;

FIG. 7 is a schematic diagram of generating a pseudo sample based on an instruction template according to an aspect of this disclosure;

FIG. 8 is a similarity table of a relation prototype determined based on a first model according to an aspect of this disclosure;

FIG. 9 is a schematic structural diagram of an electronic device according to an aspect of this disclosure;

FIG. 10 is a schematic structural diagram of a model training apparatus according to an aspect of this disclosure;

FIG. 11 is a schematic flowchart of a classification method according to an aspect of this disclosure;

FIG. 12 is a schematic structural diagram of a classification apparatus according to an aspect of this disclosure; and

FIG. 13 is a schematic diagram of an internal structure of a computer device according to an aspect of this disclosure.

### DETAILED DESCRIPTION

Technical solutions in aspects of this disclosure are described with reference to the accompanying drawings. The described aspects are merely some rather than all of the aspects of this disclosure. Other aspects obtained by a person skilled in the art based on this disclosure shall fall within the scope of this disclosure. Examples of terms involved in the aspects of the disclosure are briefly introduced. The descriptions of the terms are provided as examples only and are not intended to limit the scope of the disclosure.

In addition, the terms “first”, “second”, and the like in the description of the embodiments of this disclosure are merely used for the purpose of distinguishing description, and cannot be understood as indicating or implying relative importance. Therefore, features limited by “first” and “second” may explicitly or implicitly include one or more such features. In the description of the embodiments of this disclosure, unless otherwise specifically defined, “a plurality of” means two or more. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A model training method in an aspect of this disclosure may be run on a local terminal device or a server.

To better understand a model training method and apparatus, a classification method and apparatus, an electronic device, and a storage medium that are provided in the aspects of this disclosure are described below.

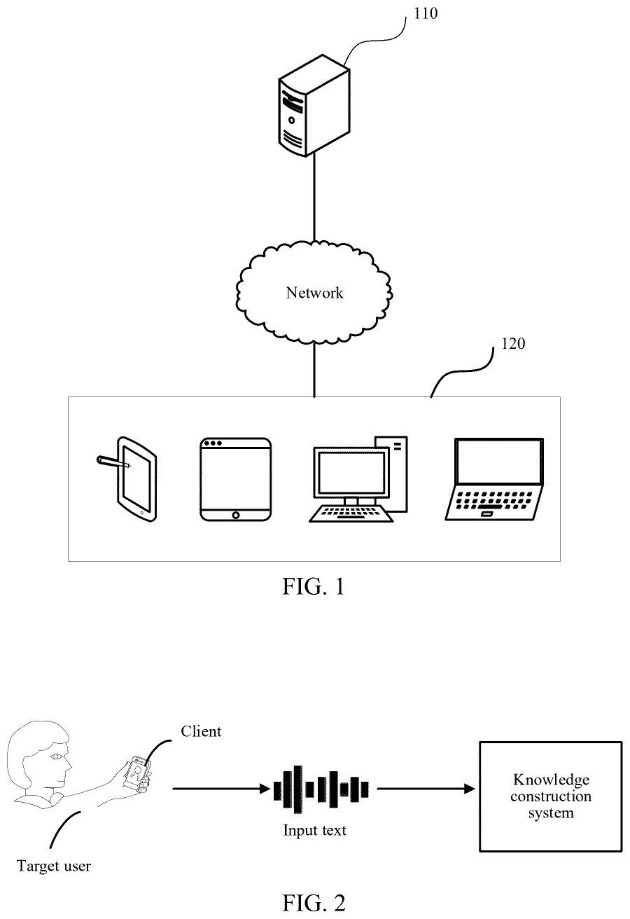

FIG. 1 is a schematic diagram of an example of a model training method according to an aspect of this disclosure. In an implementation, a model training method provided in an aspect of this disclosure may be applied to an electronic device. The electronic device may be a server 110 shown in FIG. 1, and the server 110 may be connected to a terminal device 120 through a network. The network is used to provide a medium of a communication link between the server 110 and the terminal device 120. The network may include various connection types, for example, a wired communications link and a wireless communications link. This is not limited in the aspects of this disclosure. The electronic device may alternatively be a smartphone, a notebook computer, or the like.

It should be understood that the server 110, the network, and the terminal device 120 in FIG. 1 are merely examples. There may be any quantity of servers, networks, and terminal devices according to implementation requirements. For example, the server 110 may be a physical server, or may be a server cluster formed by a plurality of servers, and the terminal device 120 may be a device such as a mobile phone, a tablet computer, a desktop computer, or a notebook computer. It may be understood that this aspect of this disclosure may further allow a plurality of terminal devices 120 to access the server 110 simultaneously.

In some aspects, the terminal device 120 may obtain a training sample for pre-training a first model and send the training sample to the server 110. The server 110 may receive the training sample to pre-train the first model, and after pre-training, the server 110 may further train the first model by using the model training method in this aspect of this disclosure, to reduce forgetting of an old relation by the first model and ensure distinguishing between similar relations by the first model. The first model may be deployed in the server 110 for use, or deployed in another electronic device such as another server or terminal for use. This is not limited in this example.

Detailed descriptions are respectively provided below with reference to the accompanying drawings. An example in which an execution body is an electronic device is used in this aspect. It should be noted that a description sequence of the following aspects is not intended to limit a preference sequence of the aspects. Although a logic sequence is shown in the flowchart, in some cases, the shown or described steps may be performed in a sequence different from the sequence shown in the accompanying drawings.

The model training method of this aspect can be applied to any scenario in which entity relation extraction needs to be performed. The method may be applied to products of these scenarios, for example, a sentiment analysis system, a knowledge base construction system, and a data analysis system.

The knowledge construction system may obtain an input text on which relation classification needs to be performed, perform feature extraction on the input text to obtain a feature vector, and perform relation classification based on the feature vector, to obtain a relation of an entity word pair in the text, thereby correspondingly storing the text (or the entity word pair in the text) and the identified relation.

FIG. 2 is a schematic diagram of an example of a model training method according to an aspect of this disclosure. FIG. 2 shows an example of applying the model training method of this solution. An input text of a target user such as “Dalbergia odorifera is mainly produced in Hainan Province of China and Vietnam” is obtained by using a client. Feature vector extraction is performed on the input text, relation classification is performed based on the feature vector, to obtain that a relation of an entity word pair of “Dalbergia odorifera” and “China” is “country of origin”. A knowledge construction system may correspondingly store the entity word pair and the relation in a knowledge base.

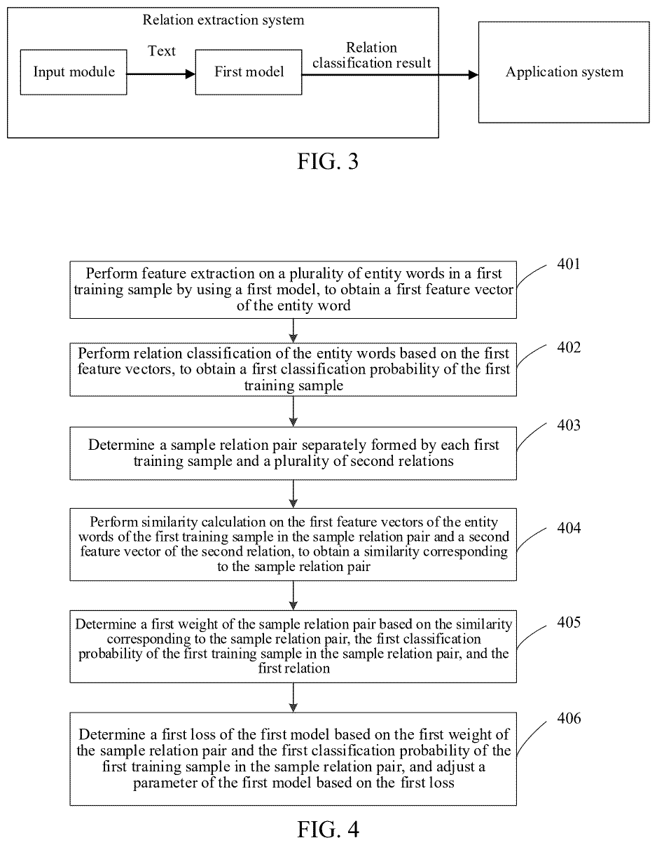

FIG. 3 is a schematic system diagram of a model training method according to an aspect of this disclosure. FIG. 3 shows an implementation of a relation extraction system to which the model training method of this solution is applied. First, a text inputted by a user is obtained by using an input module. Then, the text is inputted into a first model trained in this solution. The first model extracts a feature vector of the text, identifies a relation between entity word pairs in the text based on the feature vector, and transfers the relation to an application system connected to the relation extraction system for use. The application system may include some systems that need the relation to implement system functions, such as a sentiment analysis system, a knowledge base construction system, and a data analysis system.

Relation extraction (RE) is an important component in the fields of natural language processing and data analysis. The fields of data science and machine learning are continuously being developed. As data becomes more complex and dynamic, new challenges arise. In this field, relation extraction (RE) is a key task, and relates to identifying and classifying semantic relations in texts. With continuous evolution of data flows, an effective continuous relation extraction (CRE) requirement becomes increasingly important. This process needs to adapt to a new relation pattern and type, and reserve previously learned information. During learning of a new task, avoiding catastrophically forgetting an old task is a challenge in continuous learning.

The following describes features of relation extraction and continuous relation extraction in detail.

Relation extraction: means that for a given target entity pair and a to-be-extracted text, the target entity pair and the text corresponding to the target entity pair are sent to a model, to extract a relation of the target entity pair.

Continuous relation extraction: mainly focuses on automatically extracting a relation between entities from text data. Compared with related relation extraction, continuous relation extraction focuses on extracting a relation in real time or dynamically, and is usually used for processing flow data or a constantly updated data set.

In the related technology, a sample subset of a previous task is generally stored and replayed in a training period of a new task based on a memory method, thereby reducing memory forgetting of a model. During replay training, a relation in a new task may be similar to a relation in an old task, causing a challenge to relation classification of a model.

Based on the foregoing problem, in this solution, at a replay stage, a sample-relation pair is constructed, and a plurality of sample-relation pairs formed by a same sample and a plurality of relations are assigned a corresponding first weight based on a similarity between a sample and a relation and a classification probability of the sample, and a loss of a first model is calculated based on the first weight, to force the model to pay attention to a similar relation, thereby improving distinguishing between similar relations by the first model at the replay stage.

FIG. 4 is a schematic flowchart of an aspect of a model training method according to an aspect of this disclosure. A specific process of the model training method may be step 401 to step 406 as follows:

Step 401: Perform feature extraction on a plurality of entity words in a first training sample by using a first model, to obtain first feature vectors of the entity words, the first training sample including at least a part of training samples for pre-training the first model, and the plurality of entity words of the first training sample having a first relation.

For example, the pre-training in this application may be sequentially training the first model by using training samples of a plurality of tasks, and a quantity of tasks is not limited.

Either the training sample or the first training sample includes a text, the text includes a plurality of entity words, the sample is configured with a tag, and the tag indicates a relation between the entity words in the sample.

A quantity of entity words in one sample is not limited, and may be set according to an actual situation. For example, one sample includes two entity words, namely, a head entity and a tail entity. The quantity of entity words in the sample may alternatively be 3. The quantity of entity words included in a specific sample is not limited in this disclosure. In addition, quantities of entity words in different first training samples may be different. This is not limited in this example.

This aspect of this disclosure is performed after the first model is pre-trained, and may be considered as a replay stage.

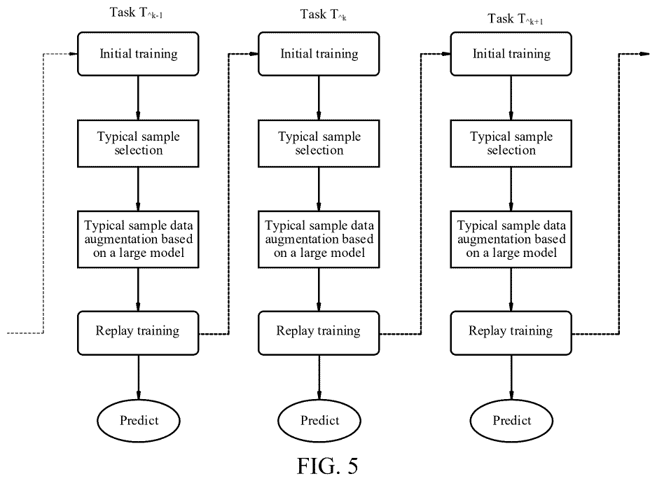

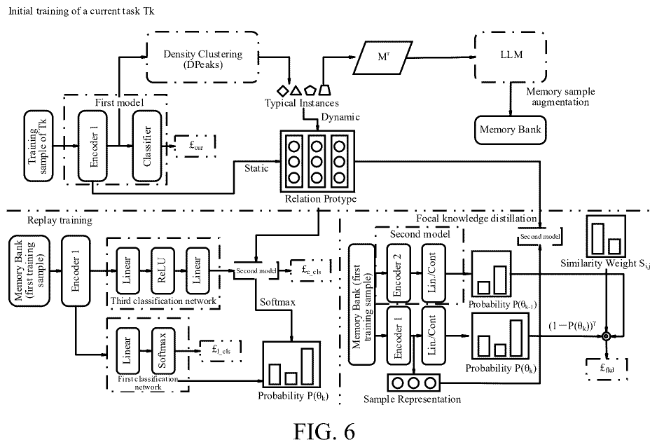

In an aspect of this disclosure, a classification model is used for performing relation extraction, that is, the first model, is improved around the replay training stage. For ease of understanding, a training solution of the first model in this aspect of this disclosure is first briefly described with reference to FIG. 5 and FIG. 6. As shown in FIG. 5, two stages, an initial training stage and a replay stage, are mainly included. It may be understood that the initial training stage may be considered as pre-training. For the pre-trained first model, a quantity of pre-training times is not limited.

The first stage is an initial training stage of a current task T_{K}.

For a text in a training sample of the current task T_{K}, for example, a sample sentence Sᵢ, the sample sentence and a header entity eₕ and a tail entity eₜ (that is, an entity word pair in this application) are jointly used as an input to the first model, and special tags [CLS] and [September] may be inserted into the sentence. [E₁₁], [E₁₂], [E₂₁], and [E₂₂] represent start/end positions of the sentence, the head entity, and the tail entity. Specifically, an input sequence of training samples is defined as follows:

$${x}_{input} = \{ [ CLS ] , {x}_{1} , , [ {E}_{11} ] , {e}_{h} , [ {E}_{12} ] , , [ {E}_{21} ] , {e}_{t} [ {E}_{22} ] , , {x}_{n} , [ SEP ] \}$$

Referring to a schematic diagram of a model training method shown in FIG. 6, at an initial training stage of a current task TK, a training sample of the current task T_{K} is input to an encoder (referring to an encoder 1 in FIG. 6, the first model further includes a classifier connected to the encoder 1) of the first model. Each element in xᵢₙₚᵤₜ is understood by the encoder with reference to the context, to obtain a latent vector of each element.

In an example, hidden states (that is, latent vectors) of [E₁₁] and [E₂₁] may be used to represent the head entity and the tail entity. Then, the representation is defined as follows:

$${h}_{{x}_{input}} = LayerNorm ( {W}_{1} [ {h}_{{x}_{input}}^{11} ; {h}_{{x}_{input}}^{21} ] + b ) [ {h}_{{x}_{input}}^{11} ; {h}_{{x}_{input}}^{21} ]$$

is a representation of the head entity and the tail entity and is formed by concatenating two latent vectors

$${h}_{{x}_{input}}^{11} and {h}_{{x}_{input}}^{21} , {h}_{{x}_{input}}^{11} and {h}_{{x}_{input}}^{21}$$

are extracted by the encoder 1 of the first model (refer to the encoder 1 at the initial training stage of the current task T_{K} in FIG. 6), and W₁ and b are model parameters of the encoder 1. In some other aspects, the head entity and the tail entity may alternatively be represented by using hidden states of other elements, such as hidden states of [E₁₂] and [E₂₂].

The encoder 1 then passes hₓ_{ᵢₙₚᵤₜ} to a linear softmax layer (that is, the classifier in FIG. 6) to calculate a corresponding relation classification probability of the entity word pair in the sentence Si. That is, the relation classification probability of the input sequence xᵢₙₚᵤₜ is:

$$P ( {x}_{input} ; {θ}_{k} ) soft max ( {W}_{2} {h}_{{x}_{input}} )$$

θₖ indicates a parameter of the first model when learning the current task T_{K}. W₂ is a training parameter of the linear softmax layer (that is, the classifier in FIG. 6). An initial training loss of the current task T_{K} is calculated as follows:

$${ℒ}_{cur} = - \frac{1}{\vert {{D}_{K}}^{Train} \vert} {\sum }_{{x}_{i} ∈ {{D}_{K}}^{Train}} {\sum }_{{r}_{j} ∈ {R}_{k}} {δ}_{{y}_{i} , {r}_{j}} log P ( {r}_{j} \vert {x}_{i} ; {θ}_{k} )$$

D_{K}^{Train} is a training sample set of a kth task T_{K} of the first model, xᵢ is an ith sample in the training sample set, Rₖ is a first relation set of the kth task T_{K} of the first model and includes a first relation of the training sample, and P (rⱼ|xᵢ; θₖ) is a classification probability of currently classifying an input sequence xᵢ into a relation rⱼ by the first model by using a parameter θₖ. yᵢ is a real first relation between a head entity eₕ and a tail entity eₜ in the input sequence xᵢ. In formula (4), if yᵢ=rⱼ, then δ_{y}_{ᵢ}_{,r}_{ⱼ}=1; otherwise δ_{y}_{ᵢ}_{,r}_{ⱼ}=0.

For example, for a training sample in which a first relation is “country of origin”, a text in the sample is “[CLS][E11] Dalbergia odorifera [E12] is mainly produced in Hainan Province of [E21] China [E22] and Vietnam [September]”, and an extracted first feature vector may be understood as a concatenated vector of feature vectors extracted for “Dalbergia odorifera” and “China” from the text. A first classification probability that the classifier has for the first feature vector includes a probability that the entity word pair is classified into a plurality of first relations (including the country of origin).

After the parameter of the first model is adjusted based on the initial training loss, the initial training stage of the current task T_{K} is completed, and the model learns knowledge in the current task T_{K}. In this training, the first model generally forgets knowledge of an old task. The training stage of the current task T_{K} further includes a second stage, that is, a replay training stage. Training samples corresponding to relations of some old tasks are used for retraining the first model, so as to reduce knowledge forgetting.

Before the replay training, a typical sample needs to be selected. A typical sample refers to: a representative sample in a plurality of training samples corresponding to a first relation.

After learning the current task T_{K}, to preserve the knowledge learned from the previous task, for each relation r, some typical samples are usually selected and stored in the related technology for memory replay.

For example, after the initial training stage of the kth task ends, before an initial training stage of a (k+1)th task starts, typical samples of the previous K tasks (including the current task T_{K}) are used for performing replay training on the first model, where the typical sample of each task is selected from training samples of the task.

After the replay training stage corresponding to the current task T_{K} ends, a training sample of the training task is extracted based on a (k+1)th relation, and initial training is performed. Therefore, replay training can alleviate knowledge forgetting of an old task by the encoder in the first model.

The first model in step 401 of this aspect of this disclosure undergoes at least the foregoing described initial training stage, that is, a plurality of times of pre-training.

Replay training is to alleviate forgetting of old knowledge by the first model. Therefore, it may be understood that selection of the first training sample may ensure that the first model memorizes knowledge in pre-training after training for a plurality of times. It may be understood that in an example, the first training sample may include at least a part of training samples of a plurality of times of pre-training, for example, at least a part of training samples of current pre-training and all pre-training before the current pre-training, so that the first model can reserve relatively comprehensive knowledge about all learned relations. For example, as described from a task perspective, when a current task is T_{K}, the first training sample includes the first K tasks, that is, a part of training samples of T₁-T_{K}.

In another example, a part of tasks may be selected as a target task, and at least a part of training samples of the target task is obtained, to obtain the first training sample. Alternatively, a part of target tasks may be selected from a current task and all historical tasks before the current task according to actual needs. For example, an unimportant task may not be selected as a target task during replay, or the target task may include at least one of historical tasks undergoing the initial training stage, or the target task may include a current task (for example, a current Kth task T_{K}) and at least one historical task before the current task.

Alternatively, in another example, all historical tasks before a current task may be divided into a plurality of sets according to a rule and a replay order is set. After an initial training stage of each new task, tasks of a set are selected based on the replay order to perform replay training. In this way, replay training may be performed on the tasks of the set alternately. When a quantity of replay training samples is reduced, it can be ensured that the first model reserves knowledge about more relations.

In an example of this disclosure, at least one relation that needs to be learned by the first model may be set in one task. That is, a quantity of first relations in one task may be at least one. Therefore, one task may include a training sample corresponding to at least one relation.

At least a part of the first training sample comes from a training sample of a target task. For example, the first training sample is a sample selected from training samples of a target task, or the first training sample includes a sample selected from training samples of a target task and a sample generated in another manner.

In an example, for each first relation involved in a pre-trained training sample, whether to obtain a training sample as a first training sample may be determined according to a requirement. For example, a first training sample corresponding to each first relation may be obtained. Alternatively, corresponding first training samples may be obtained only for some first relations. This is not limited in this aspect.

In the related technology, after a typical sample is selected, model replay training may be performed. However, the first model is continuously updated, continuous replay of memory samples such as typical samples continuously exacerbates the problem of model overfitting. In view of this, a memory augmentation solution for the typical sample is proposed. A pseudo sample in addition to the typical sample is added in the first relation, and the typical sample and the pseudo sample corresponding to the first relation are both used as first training samples at the replay stage, thereby reducing overfitting of the first model.

Therefore, referring to FIG. 5, in some aspects, before replay training, typical sample data augmentation of a large model is performed. In this aspect, a method for obtaining a first training sample of a first model includes:
obtaining a second training sample, the second training sample including a part of training samples for pre-training the first model;
performing sample generation processing based on a first relation corresponding to the second training sample, to obtain a third training sample corresponding to the first relation, entity words in the third training sample having the first relation; and
obtaining the first training sample of the first model based on the second training sample and the third training sample.

A text needed in the third training sample may be generated by using an AI model based on a relation name in the first relation corresponding to the second training sample, to obtain the third training sample (considered as a pseudo sample of the first relation).

For example, an instruction template of the AI model may be obtained, the relation name is filled in a filling position corresponding to the instruction template, to obtain a generation instruction, and the AI model is controlled to generate a third training sample of each relation name based on the generation instruction.

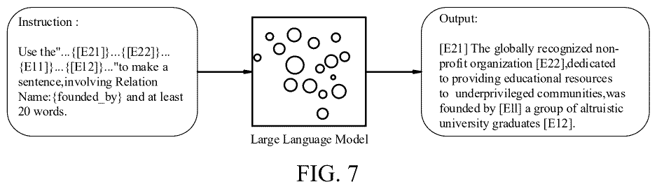

The AI model may include a large language model (LLM). FIG. 7 shows an example of an instruction template on the left. The template provides head and tail tags of an entity word pair, a filling position of a relation name, and instruction information instructing the AI model to generate a text according to the relation name. Further, a limitation on a generated text may be indicated. For example, the generated text is limited in FIG. 7 to include at least 20 words. The generation instruction may be obtained based on the instruction template and the relation name of the second training sample. The generation instruction is input into the large language model, and the large language model may generate a text in the third training sample (that is, the pseudo sample).

For example, in the example shown in FIG. 7, in { } after Name in the instruction template, a first relation “founded-by” is filled in, and a text generated by the large language model is “[E21] The globally recognized non-profit organization [E22], dedicated to providing educational resources to underprivileged communities, was founded by [E11] a group of altruistic university graduates [E12].”.

For example, for a first relation “country of origin”, a text in a pre-trained training sample is “[E11] Dalbergia odorifera [E12] is mainly produced in Hainan Province of [E21] China [E22] and Vietnam”. In this application, a similar text is expected to be generated by using the large language model, and be tagged with “country of origin”, to obtain a third training sample. In this case, “country of origin” is filled in { } after Name in the instruction template shown in FIG. 7, and then an instruction is input into the large language model, to obtain a required text, that is, a statement including a plurality of entity words having a relation of “country of origin”.

Therefore, at each replay training stage, a sample augmentation policy may be executed. During replay training, pseudo samples of some first relation are input into the first model, and the first model may learn new knowledge corresponding to the relation from the samples, to alleviate a decrease in a generalization capability of the first model and alleviate overfitting.

It may be understood that in this disclosure, a typical sample augmentation solution based on a large model does not necessarily need to be executed during each time of replay training. An implementation frequency of the solution may be selected according to an actual requirement, and this example is not limited thereto.

In addition, in this disclosure, whether replay training needs to be performed after each task is pre-trained may also be determined according to a requirement. In an example, pre-training and replay training may be performed on each task. In another example, a frequency of replay training may be less than a frequency of pre-training. For example, replay training is performed once every two times of pre-training.

For example, the second training sample (that is, the foregoing typical sample) may be selected from pre-trained training samples and stored. A typical sample of each task may be stored in a same storage space, for example, in a same database, for obtaining during replay training. For example, referring to FIG. 6, a typical sample of each task is stored in a memory bank.

A same quantity of second training samples or different quantities of second training samples may be selected for each first relation involved in a pre-trained training sample.

Selection of a typical sample is important to alleviating an effect of memory forgetting. In some related technologies, training samples in a same first relation are clustered into L clusters by using a K-means algorithm, and a typical sample is selected from each cluster. However, in this clustering manner, an initial cluster center is usually randomly selected. Because the k-means algorithm is sensitive to an initial value and to an abnormal value and noise data, the algorithm may converge to a local optimum rather than a global optimum, and a selected typical sample lacks representativeness and diversity, causing degradation of performance of the first model for an old task.

In view of this, this disclosure provides a manner of selecting a typical sample based on density clustering.

The training samples for pre-training the first model include the training sample for pre-training the first task and the second task of the first model, and the obtaining a second training sample includes:
calculating, for training samples that correspond to a same first relation and that are in the first task, a local density and a distance parameter of each training sample, the distance parameter being used for indicating a distance between the training sample and another training sample that corresponds to the same first relation;
selecting, based on the local densities and the distance parameters of the training samples corresponding to the same first relation, a second training sample corresponding to the first relation from the training samples; and
obtaining a second training sample corresponding to each first relation in the second task.

It may be understood that, the second training sample corresponding to the second task is also selected based on a local density and a distance parameter. In this aspect of this disclosure, the second task of the first model is trained first, and then the first task of the first model is trained.

Local densities and distance parameters of training samples corresponding to a same first relation may be calculated based on first feature vectors extracted for entity words in texts of the training samples.

In this disclosure, with reference to two indicators: the local density and the distance parameter, a training sample having a high local density and a low distance parameter is selected as a typical sample.

In an example, the selecting, based on the local densities and the distance parameters of the training samples corresponding to the same first relation, a second training sample corresponding to the first relation from the training samples may include:
multiplying a local density by a distance parameter of a same training sample, to obtain a product value; and
selecting, for training samples corresponding to a same first relation, a second training sample from the training samples in descending order of products of the training samples, to obtain the second training sample corresponding to each first relation.

A quantity of second training samples selected in each first relation may be the same or different. This is not limited in this example. For example, a quantity of typical samples corresponding to each first relation is defined as a memory size m.

In another example, the selecting, based on the local densities and the distance parameters of the training samples corresponding to the same first relation, a second training sample corresponding to the first relation from the training samples may include:
normalizing the local density and the distance parameter to obtain a normalized density and a normalized distance;
performing weighted summation based on the normalized density and a density weight and the normalized distance and a distance weight, to obtain a target indicator value of each training sample; and
selecting, for training samples corresponding to a same first relation, a second training sample from the training samples in descending order of target indicator values of the training samples.

Alternatively, in another aspect, the selecting, based on the local densities and the distance parameters of the training samples corresponding to the same first relation, a second training sample corresponding to the first relation from the training samples may further include:
selecting, based on a preset sample quantity for training samples corresponding to a same first relation, a target quantity of fourth training samples in descending order of the local densities, the target quantity being not less than two times of the preset sample quantity; and
selecting, for the fourth training samples corresponding to a same first relation, the preset sample quantity of second training samples in ascending order of the distance parameters for the selected fourth training samples.

For example, a calculation solution of the local density may include:
calculating, for training samples corresponding to a same first relation, a first similarity between the training sample and another training sample in the first relation; and
calculating a local density of each training sample in the first relation based on a first similarity and a truncation distance of the training sample.

A sample xᵢ of a relation yᵢ in a current task T_{K} is used as an example, and a local density of the sample xᵢ is defined as:

$${ρ}_{{x}_{i}} = {\sum }_{( {x}_{i} ∈ {{D}_{K}}^{Train} ) \hat{} ( {x}_{i} , {x}_{j} ∈ {y}_{i} )} {e}^{- {( \frac{{d}_{i , j}}{{d}_{c}} )}^{2}}$$

xᵢ is an ith sample in a training sample set D_{K}^{Train} of the current training task T_{K}, xⱼ is a jth sample in the training sample set D_{K}^{Train} of the current training task T_{K}, d_{i,j} represents a first similarity between xᵢ and xⱼ, and d_{c} represents a truncation distance and may be set according to a requirement. For example, a value of a specific proportion (for example, 1% to 2%) of a total quantity of training samples in a first relation yᵢ may be used as a set value of d_{c}. (xᵢ, xⱼ∈yᵢ) represents that real first relations of samples xᵢ and xⱼ are the same (that is, tags are the same), and both are yᵢ.

$$( {x}_{j} ∈ {D}_{K}^{Train} ) \hat{} ( {x}_{i} , {x}_{j} ∈ {y}_{i} )$$

represents that the sample xⱼ belongs to the training sample set D_{K}^{Train}, of the current task T_{K}, and first relations thereof and the sample xᵢ the first relation yᵢ in the current task T_{K}.

For example, for the first relation “country of origin”, a quantity of first training samples thereof is n, that is, there are n texts corresponding to the first relation. The first similarity is a similarity between a first feature vector corresponding to an entity word in a text and a first feature vector corresponding to an entity word in another text in the first relation. The similarity may include a Euclidean distance.

A calculation manner of a distance parameter of a training sample may include:
calculating, for each training sample corresponding to a same first relation, a second similarity between the training sample and another training sample in the first relation; and
determining a distance parameter of each training sample based on the second similarity of the training sample.

Calculation manners of the first similarity and the second similarity are not limited in this disclosure. In an example, a cosine similarity may be used.

The second similarity is similar to the first similarity, and is also obtained by performing vector similarity calculation based on first feature vectors corresponding to entity words in texts of different training samples.

The distance parameter is generally a distance between a sample point and a sample point having a greater density than that of the sample point. For example, according to this definition, for each sample xᵢ of a relation yᵢ in a task T_{K}, a distance parameter δₓ_{ᵢ} is as follows:

$${δ}_{{x}_{i}} = {min}_{k : {ρ}_{{x}_{k}} \geq {ρ}_{{x}_{i}}} ( {d}_{i , k} )$$

First relations of xᵢ and xₖ are the same, and d_{i,k} represents a second similarity between xᵢ and xₖ.

For a sample point having a highest density, there is no sample point having a greater density than that thereof. Therefore, a distance parameter is calculated based on second similarities between a training sample and a plurality of other training samples belonging to a same first relation. In an aspect, a global maximum distance may be defined as the distance parameter of the training sample. That is, for a sample xᵢ having a highest density, δₓ_{ᵢ}=maxₖ(d_{i,k}).

That is, for a training sample, a maximum value in second similarities between the training sample and a plurality of training samples belonging to a same first relation is used as a distance parameter of the training sample.

Therefore, at a replay training stage, a new typical sample selection solution is used, which is beneficial to resolving lack of representativeness and diversity of samples existing in an existing sample selection solution by means of K-means clustering.

At the second stage, that is, the replay training stage, the first training sample is input into the first model, to perform relation classification, thereby performing parameter adjustment on the first model based on the classification probability, and completing training at the replay stage. In the related technology, the loss at the replay stage may use a calculation manner similar to that at the initial training stage.

It can be learned by referring to FIG. 6 that, the first model includes the encoder 1 and the classifier. In step 401, feature extraction is performed on the first training sample by using the encoder 1 of the first model, to obtain the first feature vector. For a specific process of extracting the first feature vector, reference can be made to the extraction performed by the encoder 1 on a feature vector representation of a training sample at the initial training stage. Details are not described herein again.

Step 402: Perform relation classification on the entity words based on the first feature vectors, to obtain a first classification probability of the first training sample.

For example, relation classification in step 402 may be performed based on a classifier of the first model. Alternatively, according to design of a loss function, another classification network may be set to be connected to the encoder 1, so as to predict the first classification probability according to the first feature vector input by the encoder 1 into the classification network.

A quantity of classification networks is not limited, and a structure of the classification network is not limited. For example, the classification network may include at least one linear layer and at least one logic mapping layer. The logic mapping layer maps a plurality of output value ranges of the linear layer to [0, 1], and constrains a sum of output values of output nodes to 1. The logic mapping layer varies according to different selected activation functions, and a type of the activation function includes but is not limited to softmax.

It may be understood that, use of a plurality of classification networks may enable evaluation of a model loss value to be more comprehensive and accurate, thereby helping improve a replay training effect.

Generally, the first model is pre-trained, and a first relation of a training sample in the current pre-training is added to an output end of the first model, to be used as a new classification category. In this example, the first classification probability of the first training sample may include a probability that the entity words in the first training sample are classified into a plurality of first relations.

It may be understood that in a continuous training process, some newly appearing relations are similar to other learned relations, and cannot be distinguished. This disclosure may use focal knowledge distillation, to force a model to pay more attention to similar relations.

In an example, a unique weight may be allocated to each sample-relation pair, and calculation is performed according to a first classification probability of the sample and a similarity indicated between the sample and the relation. Therefore, a difficult sample and a similar sample-relation pair are assigned a high weight.

Step 403: Determine sample-relation pairs separately formed by each first training sample and a plurality of second relations, the second relation including at least a part of first relations corresponding to the training samples for pre-training the first model. In an example, a plurality of sample-relation pairs formed by the first training sample and each relation of a plurality of second relations are determined. The second relations include at least a part of the one or more first relations.

The second relation may include all first relations. For example, each first training sample forms a sample-relation pair with each first relation. Therefore, for one first training sample, there are a plurality of sample-relation pairs.

The second relation may be a part of the first relation, and a rule for selecting the second relation from the first relation is not limited, for example, according to pre-training time of the training sample corresponding to the first relation and importance of a relation.

The training samples for pre-training the first model include training samples for pre-training a first task and a second task of the first model, and the second task precedes the first task. The second relation may be selected from a first relation of a training sample of at least one second task.

For example, the second relation includes a first relation of a training sample of a second task previous to the first task.

Step 404: Perform similarity calculation on the first feature vectors of the entity words of the first training sample in the sample-relation pair and a second feature vector of the second relation, to obtain a similarity corresponding to the sample-relation pair.

The second feature vector is a vector representation of a relation, and may also be referred to as a relation prototype.

In the related technology, research has also been conducted on calculating a relation prototype of a relation r by using a feature vector of a typical sample, which is applied to relation classification. For the relation r, a vector representation of the relation is indicated by using a relation prototype. The relation prototype is usually calculated based on a feature vector representation of a typical sample. For example, the relation prototype is represented by using an average value of first feature vectors of a plurality of typical samples in the relation. However, such a method for deducting a relation prototype is very sensitive to quality of a typical sample, and may cause a deviation represented by the prototype. To alleviate the sensitivity, a method for generating a relation prototype by using knowledge is introduced in the related technology. Generation of a prototype is guided by using a relation definition text and a knowledge prompt. However, this knowledge injection technology cannot resolve a deviation caused by typical sample distribution quality. For example, typical samples selected by using a clustering algorithm may be excessively concentrated in some regions and relatively sparse in other regions, and these concentrated regions may become more concentrated with a continuous learning process. Directly calculating the prototype from these samples may cause the prototype to deviate from the real center.

Accuracy of expressing a relation by a relation prototype is very important to reduce memory forgetting. A model parameter changes continuously as a training task is performed for a model, which also poses a challenge to an accurate expression of the relation prototype.

For a same first relation, it is considered that a plurality of feature components of the first relation are obtained by using training sample calculation solutions of different features, and then a relation prototype is obtained by fusing the plurality of feature components, to reduce a deviation of the foregoing relation prototype. For example, at the replay stage, a dynamic relation prototype of the first relation is calculated based on a first training sample used for replay training, and a task-adaptive relation prototype (that is, the second feature vector) of the first relation is calculated based on the dynamic relation prototype (that is, a sixth feature vector below) and a static second relation prototype (that is, a seventh feature vector below) of the first relation, to improve memory of the first model for an old task at the replay stage.

In an aspect, for each first relation, a sixth feature vector of the first relation may be calculated based on a first feature vector of an entity word in a first training sample corresponding to the first relation. A seventh feature vector of the first relation is obtained; and a second feature vector of the first relation is determined based on the sixth feature vector and the seventh feature vector of the first relation.

That is, for each first relation, the sixth feature vector of the first relation is calculated based on the first feature vector extracted for the entity word in the text of the first training sample in the relation.

For example, for the first relation “country of origin”, if a quantity of first training samples is 20, a sixth feature vector of “country of origin” needs to be calculated based on 20 first feature vectors extracted for entity words from texts of the 20 samples.

The seventh feature vector is obtained by classifying a training sample corresponding to the first relation by using a first model pre-trained by the training sample corresponding to the first relation.

For example, first feature vectors of all first training samples in each first relation are averaged, to obtain the sixth feature vector corresponding to the first relation.

In another example, considering that there is a pseudo sample (that is, the third training sample) generated by a large model in the first training sample, purity of sample data may be affected, and the prototype may be offset, when the sixth feature vector is calculated, the first feature vector of the third training sample may be controlled not to participate in calculation.

A method for calculating a sixth feature vector includes: calculating, for each first relation, a sixth feature vector corresponding to the first relation based on a first feature vector corresponding to an entity word in a second training sample in the first training sample.

For example, for the first relation “country of origin”, a quantity of first training samples is 20, a quantity of second training samples is 15, and a quantity of third training samples is 5. Therefore, a sixth feature vector of “country of origin” needs to be calculated based on 15 first feature vectors extracted for entity words from texts of the 15 second samples.

Referring to FIG. 6, the pseudo sample generated by using the large model may also be stored in the memory bank. In this example, before the relation prototype is calculated, the third training sample may be deleted from the memory bank, to further ensure purity of the memory sample.

In this disclosure, the seventh feature vector is calculated by using a feature vector of a training sample during pre-training. Generally, after the first model is pre-trained each time based on a training sample, the first model memorizes the training sample very deeply and comprehensively, and the feature vector of the training sample extracted by using the first model includes more knowledge. Therefore, after an initial training stage of each task, the feature vector of the training sample of the task may be extracted by using the trained first model and stored for subsequent replay. The feature vector is not updated as the parameter of the model is updated, is in a relatively static state, and may be understood as a static feature component corresponding to the first relation.

After each time of pre-training, a seventh feature vector may be calculated for a first relation of a training sample in the pre-training process. For example, after current pre-training of the first model is completed, a feature vector is extracted for a training sample of the current pre-training based on the first model; and
for each first relation in the training sample of the current pre-training, feature vectors of training samples corresponding to a same first relation are averaged to obtain a seventh feature vector corresponding to the first relation.

For example, the current pre-training includes a training sample corresponding to the first relation “country of origin”, and a quantity of training samples is 100. After the current pre-training is completed, feature vectors may be extracted for the training samples of the current pre-training by using the first model. For example, for the 100 training samples of “country of origin”, feature vectors are respectively extracted for entity words in 100 texts in the 100 samples, to obtain 100 feature vectors. The 100 feature vectors are then averaged, to obtain a seventh feature vector of the first relation “country of origin”, and the seventh feature vector is stored. After the storage, unless a new training sample of the “country of origin” is provided in new pre-training, otherwise the seventh feature vector of the “country of origin” remains unchanged in subsequent training of the first model.

It can be known from the foregoing descriptions that in each time of replay training, the encoder 1 of the first model re-extracts, based on a text in the first training sample, the first feature vector of the entity word in the text, and calculates the sixth feature vector. The parameter of the first model changes with task training. Therefore, the sixth feature vector dynamically changes, that is, is equivalent to a dynamic feature component of the first relation.

In this aspect of this disclosure, the static seventh feature vector that includes more comprehensive relation knowledge and the dynamic sixth feature vector are used, so that the second feature vector can adapt to a change of an expression of the first model for the relation knowledge caused by a change of a training task, thereby alleviating a problem of memory forgetting of the first model.

The feature component of the first relation may be fused based on a weight. In some embodiments, the determining a second feature vector of the first relation based on the sixth feature vector and the seventh feature vector of the first relation includes:
obtaining a third weight corresponding to the sixth feature vector and a fourth weight corresponding to the seventh feature vector; and
performing, for a same first relation, weighted summation based on the sixth feature vector of the first relation, the third weight, the seventh feature vector, and the fourth weight, to obtain the second feature vector of the first relation.

A sum of the third weight and the fourth weight may be 1. In an example, the fourth weight is not less than the third weight, and the relation prototype is more determined by a static feature of the training sample. Alternatively, in an example, the fourth weight is lower than the third weight, and the relation prototype is more determined by a dynamic feature of a typical sample.

For example, for a task-adaptive relation prototype (that is, the second feature vector) of th relation r, a static representation of the relation prototype is fine-tuned by using a dynamic representation of a typical sample. The task-adaptive relation prototype is defined as follows:

$${RP}_{r} = α \frac{{\sum }_{{x}_{i} ∈ {M}^{R}} {Z}_{{x}_{i}}}{\vert {M}^{r} \vert} + ( 1 - α ) {RP}_{r}^{static}$$

M^{r} represents a typical sample set in the relation r, xᵢ is an ith sample in the typical sample set M^{r} in the relation r, |M^{r}| represents a sample quantity of the typical sample set M^{r}, and

$${RP}_{r}^{static}$$

is an average representation (that is, a seventh feature vector) of feature vectors corresponding to entity words in texts of all training samples in the relation r; and zₓ_{ᵢ} is a normalized representation of a first feature vector of a typical sample of the relation r stored in the memory bank. α is a hyper-parameter, and may be set according to reliability and importance of an actual static feature and dynamic feature, for example, selected as 0.6.

A first feature vector of a typical sample is extracted by the encoder 1 of the first model. For example, the feature vector is

$${h}_{{x}_{input}} = LayerNorm ( {W}_{1} [ {h}_{{x}_{input}}^{11} ; {h}_{{x}_{input}}^{21} ] + b ) .$$

Step 405: Determine a first weight of the sample-relation pair based on the similarity corresponding to the sample-relation pair, the first classification probability of the first training sample in the sample-relation pair, and the first relation.

It can be learned from the foregoing that, one first training sample corresponds to a plurality of sample-relation pairs, and one first relation also has a plurality of sample-relation pairs. Therefore, a weight coefficient may be set for a sample-relation pair according to a similarity between a training sample in the sample-relation pair and another sample-relation pair, to calculate a first weight.

The determining a first weight of the sample-relation pair based on the first classification probability of the first training sample in the sample-relation pair and the first relation may include:
calculating a similarity parameter corresponding to the first training sample based on a similarity between a plurality of sample-relation pairs including the same first training sample;
determining, for each sample-relation pair, a weight coefficient of the sample-relation pair based on the similarity parameter of the first training sample in the sample-relation pair and a similarity corresponding to the sample-relation pair; and
determining a first weight of the sample-relation pair based on the weight coefficient of the sample-relation pair, the first classification probability of the first training sample in the sample-relation pair, and the first relation.

The first classification probability includes a probability that the first training sample is classified into a plurality of first relations, and a specific step of determining a first weight may include: determining a first weight of the sample-relation pair based on the weight coefficient of the sample-relation pair and a first probability that is in the first classification probability and that is of the first training sample in the sample-relation pair. The first probability is a probability that the first training sample is classified into a corresponding first relation.

For example, a formula of a weight coefficient Sₓ_{ᵢ}_{,r}_{ⱼ} of a sample-relation pair formed by a sample xᵢ and a relation rⱼ and a first weight ωₓ_{_{i,}}ᵣ_{ⱼ} is as follows:

$${s}_{{x}_{i} , {r}_{j}} = \frac{exp ( sim ( {x}_{i} , {RP}_{{r}_{j}} ) / {τ}_{1} )}{{\sum }_{{r}_{m} ∈} exp ( sim ( {x}_{i} , {RP}_{{r}_{m}} ) / {τ}_{1} )}$$

$${ω}_{{x}_{i} , {r}_{j}} = {{s}_{{x}_{i} , {r}_{j}} ( 1 - P ( {y}_{i} \vert {x}_{i} ; {θ}_{k} ) )}^{γ}$$

[symbol] represents a first relation set corresponding to a (K−1)th task, RPᵣ_{ⱼ} and RPᵣ_{ₘ} are relation prototypes (that is, second feature vectors) of relations rⱼ and rₘ, sim(⋅) is a cosine similarity function, and τ₁ is a temperature parameter and is a hyper parameter. In an example, a value of τ₁ is 0.1, and a value is 1.5. P(yᵢ|xᵢ; θₖ) is a first probability of the first training sample xᵢ.

Step 406: Determine a first loss of the first model based on the first weight of the sample-relation pair and the first classification probability of the first training sample in the sample-relation pair, and adjust a parameter of the first model based on the first loss.

This disclosure uses a focal knowledge distillation manner, to prevent overfitting of replay training of the first model and distinguishing between high similar relations.

To facilitate focal knowledge distillation, a second model connected to a knowledge bank is designed in this disclosure. Referring to FIG. 6, the second model includes an encoder 2. A structure of the encoder 2 is similar to that of the encoder 1, and differences include that the encoder 2 is equivalent to going through only a part of training tasks of the encoder 1. For example, the encoder 1 has gone through K training tasks, and the encoder 2 has gone through only the first K−1 tasks of the tasks.

In an example, a parameter of the encoder 2 may not be directly obtained through training a task thereof, but may be obtained and used from the encoder 1.

The determining a first loss of the first model based on the first weight of the sample-relation pair and the first classification probability of the first training sample in the sample-relation pair may include:
obtaining, from a second classification probability of a first training sample, a second probability that the first training sample in the sample-relation pair is a second relation in the sample-relation pair, the second classification probability being obtained by classifying the first training sample by using a second model, and the second model being obtained through training based on a part of training samples for pre-training the first model;
multiplying the first weight corresponding to the sample-relation pair by the second probability, to obtain a second weight corresponding to the sample-relation pair; and
determining the first loss of the first model based on the second weight of the sample-relation pair and a third probability that is in the first classification probability and that is of the first training sample in the sample-relation pair, the third probability being a probability that the first training sample is the second relation in the sample-relation pair.

The method further includes: performing relation classification by using the second model based on the first training sample, to obtain a second classification probability, the second model being obtained through training based on a part of training samples for pre-training the first model. That is, the second model is obtained through training based on training samples of some second tasks.

It may be understood that the second classification probability is similar to the first classification probability, and also includes a probability that a first training sample is classified into a plurality of first relations.

For example, for a sample-relation pair formed by a sample xᵢ and a relation rⱼ, a second weight is represented as follows:

$${α}_{{x}_{i} , {r}_{j}} = {ω}_{{x}_{i} , {r}_{j}} P ( {r}_{j} \vert {x}_{i} ; {θ}_{k - 1} )$$

θₖ₋₁ is a parameter of the second model, and P(rⱼ|xᵢ; θₖ₋₁) is the second probability.

The focal knowledge distillation loss is the first loss, and is represented as follows:

$${ℒ}_{f d} = - \frac{1}{\vert {\hat{M}}^{k} \vert} {\sum }_{{x}_{i} ∈ {\hat{M}}^{k}} {\sum }_{{r}_{j} ∈} {α}_{{x}_{i} , {r}_{j}} l o P ( {r}_{j} \vert {x}_{i} ; {θ}_{k} )$$

θₖ is a parameter corresponding to the current encoder 1 of the first model, and P(rⱼ|xᵢ; θₖ) is the third probability.

A model loss may be calculated by combining linear classification and focal knowledge distillation.

Linear classification is implemented based on the first classification network (referring to FIG. 6), and the performing relation classification on the entity words based on the first feature vectors, to obtain a first classification probability of the first training sample includes:
classifying relations of the entity words based on the first feature vectors by using a first classification network, to obtain the first classification probability of the first training sample; and
the performing relation classification by using the second model based on the first training sample, to obtain a second classification probability includes:
performing feature extraction on the entity words in the first training sample by using a first feature extraction network of the second model, to obtain third feature vectors of the entity words; and
classifying the relations of the entity words based on the third feature vectors by using a second classification network of the second model, to obtain a second classification probability of the first training sample, the second classification network having a same structure as the first classification network.

The second feature extraction network has a structure similar to that of a network used by the first model to extract a feature vector of an entity word, for example, the structure of the encoder 1.

In an example of linear classification, for a sample-relation pair formed by a sample xᵢ and a relation rⱼ, a second weight is represented as follows:

$${α}_{{x}_{i} , {r}_{j}}^{l} = {ω}_{{x}_{i} , {r}_{j}} P ( {r}_{j} \vert {x}_{i} ; {θ}_{k - 1} )$$

The focal knowledge distillation loss corresponding to a linear condition is the first loss, and is represented as follows:

$${ℒ}_{l \_ fd} = - \frac{1}{\vert {\hat{M}}^{k} \vert} {\sum }_{{x}_{i} ∈ {\hat{M}}^{k}} {\sum }_{{r}_{j} ∈} {α}_{{x}_{i} , {r}_{j}}^{l} log {P}_{l} ( {r}_{j} \vert {x}_{i} ; {θ}_{k} )$$

P(rⱼ|xᵢ; θₖ₋₁) is a classification probability that the second classification network classifies an input sequence xᵢ into a relation rⱼ, in a linear condition when a model parameter of the second model is θₖ₋₁, and Pₗ(rⱼ|xᵢ; θₖ) is a classification probability that the first classification network classifies the input sequence xᵢ into the relation rⱼ, in the linear condition when a model parameter of the encoder 1 is θₖ.

A second loss corresponding to the first classification network may further be calculated, and the model is optimized by combining the first loss and the second loss. The model training method of this disclosure further includes: calculating a second loss of the first model based on the first classification probability of the first training sample and the first relation; and the adjusting a parameter of the first model based on the first loss includes: adjusting the parameter of the first model based on the first loss and the second loss.

A loss function Lt [symbol] of the second loss is as follows:

$${ℒ}_{{l}_{\_ CLS}} = - \frac{1}{\vert {\hat{M}}^{k} \vert} {\sum }_{{x}_{i} ∈ {\hat{M}}^{k}} {\sum }_{{r}_{j} ∈} {δ}_{{y}_{i} , {r}_{j}} log P ( {r}_{j} \vert {x}_{i} ; {θ}_{k} )$$

[symbol] represents a first relation set of a current task Tk, and P(rⱼ|xᵢ; θₖ) is an output of the encoder 1 after the first classification network is trained based on the task T_{K}, and represents a classification probability that entity words (a header entity and a tail entity) in a text of an input sequence xᵢ of the first training sample is classified into a relation rⱼ. yᵢ is a real first relation between a head entity eₕ and a tail entity eₜ in the input sequence xi, that is, a tag. If yᵢ=rⱼ, δ_{y}_{ᵢ}_{,r}_{ⱼ}=1; otherwise, equal to 0.

Training may further be performed with reference to contrastive learning and focal knowledge distillation.

The performing relation classification on the entity words based on the first feature vectors, to obtain a first classification probability of the first training sample may include:
mapping the first feature vector by using a third classification network, to obtain a fourth feature vector; and
classifying a relation between the entity words in the first training sample based on the fourth feature vector by using the third classification network, to obtain the first classification probability of the first training sample;
that is, mapping the first feature vectors of the entity words in the text of the first training sample by using the third classification network, to obtain the fourth feature vectors corresponding to the entity words; and classifying relations between the entity words in the text by using the third classification network based on the fourth feature vectors, to obtain the first classification probability.

A structure of the third classification network is not limited. For example, referring to FIG. 6, in an example, the third classification network includes a linear layer, a normalization layer, a linear layer, and a logic mapping layer that are sequentially disposed.

The performing relation classification by using the second model based on the first training sample, to obtain a second classification probability may include:
performing feature extraction on the entity words in the first training sample by using a second feature extraction network of the second model, to obtain fifth feature vectors of the entity words; and
classifying the relations of the entity words based on the fifth feature vectors by using a fourth classification network of the second model, to obtain a second classification probability of the first training sample, the fourth classification network having a same structure as the third classification network.

The second model includes an encoder 2. For explanation of the encoder 2, reference can be made to the foregoing example, and details are not described herein again.

In an example of a contrastive learning condition, for a sample-relation pair formed by a sample xᵢ and a relation rⱼ, a second weight is represented as follows:

$${α}_{{x}_{i} , {r}_{j}}^{c} = {ω}_{{x}_{i} , {r}_{j}} P ( {r}_{j} \vert {x}_{i} ; {θ}_{k - 1} )$$

The first loss is represented as:

$${ℒ}_{C \_ fd} = - \frac{1}{\vert {\hat{M}}^{k} \vert} {\sum }_{{x}_{i} ∈ {\hat{M}}^{k}} {\sum }_{{r}_{j} ∈} {α}_{{x}_{i} , {r}_{j}}^{c} log {P}_{c} ( {r}_{j} \vert {x}_{i} ; {θ}_{k} )$$

P(rᵢ|xᵢ; θₖ₋₁) is a classification probability that the fourth classification network classifies an input sequence xᵢ into a relation rⱼ, in a contrastive learning condition when a model parameter of the encoder 2 is θₖ₋₁, and P_{c}(rⱼ|xᵢ; θₖ) is a classification probability that the third classification network classifies the input sequence xᵢ into the relation rⱼ, in the contrastive learning condition when a model parameter of the encoder 1 is θₖ.

For the third classification network, a loss corresponding thereto may be calculated, to participate in model parameter optimization.

A calculation manner of the loss is not limited. In an example, an InfoNCE loss and a triplet loss may be selected for contrastive learning and training.

In some embodiments, the model training method further includes:
determining a relation set of the first training sample, the relation set including a first relation corresponding to each first training sample;
determining, for each first training sample, a third loss of the first model according to a second feature vector of the first relation corresponding to the first training sample, a second feature vector of each first relation in the relation set, and the fourth feature vector of the first training sample;
determining, for each first training sample, a third relation corresponding to the first training sample in the relation set, a feature vector similarity between the third relation and the first relation corresponding to a same first training sample meeting a preset similarity condition; and
determining a fourth loss of the first model based on the fourth feature vector of the first training sample and second feature vectors of the first relation and the third relation of the first training sample.

For example, if there are a total of 100 first relations between entity words in texts of all first training samples, the relation set includes the 100 first relations.

A calculation solution of the third loss may include:
calculating a first dot product of the fourth feature vector of the first training sample and the second feature vector of the first relation of the first training sample;
calculating a second dot product of the fourth feature vector of the first training sample and the second feature vector of each first relation in the relation set; and
determining the third loss of the first model based on the first dot product and the second dot product.

For example, the third loss is represented as:

$$L = - \frac{1}{\vert {\hat{M}}^{k} \vert} {\sum }_{{x}_{i} ∈ {\hat{M}}^{k}} log \frac{exp ( {z}_{{x}_{i}} \cdot \frac{{z}_{{y}_{i}}}{τ} )}{{\sum }_{r ∈ {\hat{R}}^{k}} exp ( {z}_{{x}_{i}} \cdot \frac{{z}_{r}}{τ} )}$$

\hat{M}^{k} represents a memory sample set corresponding to the first K tasks of the first model (including a typical sample and a pseudo sample for model augmentation), xᵢ is an ith first training sample in the set \hat{M}^{k}, \hat{R}^{k} is a first relation set corresponding to the K tasks, zₓ_{ᵢ} represents normalization of MLP(hₓ_{ᵢ}), that is, a fourth feature vector extracted by the third classification network, and |\hat{M}^{k}| represents a quantity of memory samples in the \hat{M}^{k} set.

A calculation solution of the fourth loss may include:
calculating a third dot product of the fourth feature vector of the first training sample and the second feature vector of the first relation of the first training sample;
calculating a fourth dot product of the fourth feature vector of the first training sample and the second feature vector of the third relation of the first training sample; and
determining the fourth loss of the first model based on a difference between the fourth dot product and the third dot product.

For example, the fourth loss is represented as:

$$L = \frac{μ}{\vert {\hat{M}}^{k} \vert} {\sum }_{{x}_{i} ∈ {\hat{M}}^{k}} max ( ω - {z}_{{x}_{i}} {z}_{{y}_{i}} + {z}_{{x}_{i}} {z}_{{y}_{i}^{′}} , 0 )$$

For explanations of \hat{M}^{k}, zₓ_{ᵢ}, z_{y}_{ᵢ}, and |\hat{M}ₖ|, reference can be made to the foregoing description.

$${y}_{i}^{′} = arg {max}_{{y}_{i}^{′} ∈ {\hat{R}}^{k}} ( {z}_{{x}_{i}} )$$

is a third relation corresponding to entity words in a text corresponding to a sample xᵢ (that is, a first relation presenting the largest difference between yᵢ′ and a tag yᵢ corresponding to the sample xᵢ). τ is a temperature coefficient, and may be set to 0.08. ω and μ are hyper parameters, and may be respectively set to 0.1 and 0.5.

A sum of the third loss and the fourth loss is a contrastive learning loss, and is represented as:

$${ℒ}_{{C}_{\_ CLS}} = - \frac{1}{\vert {\hat{M}}^{k} \vert} {\sum }_{{x}_{i} ∈ {\hat{M}}^{k}} log \frac{exp ( {z}_{{x}_{i}} \cdot \frac{{z}_{{y}_{i}}}{τ} )}{{\sum }_{r ∈ {\hat{R}}^{k}} exp ( {z}_{{x}_{i}} \cdot \frac{{z}_{r}}{τ} )} + \frac{μ}{\vert {\hat{M}}^{k} \vert} {\sum }_{{x}_{i} ∈ {\hat{M}}^{k}} max ( ω - {z}_{{x}_{i}} {z}_{{y}_{i}} + {z}_{{x}_{i}} {z}_{{y}_{i}^{′}} , 0 )$$

The adjusting a parameter of the first model based on the first loss includes: adjusting the parameter of the first model based on the first loss, the third loss, and the fourth loss.

For example, the first loss, the third loss, and the fourth loss are summed to obtain a total loss, and the parameter of the first model is adjusted based on the total loss.

Each loss may be assigned a corresponding weight, and weighted summation is performed to calculate the loss of the first model.

In an instance, referring to FIG. 6, in step 402, two types of classification may be implemented by using the first classification network and the third classification network, a corresponding second classification network and fourth classification network may be set in the second model at the same time, and two types of classification are also correspondingly performed.

Therefore, in this aspect, a total loss of replay training of the encoder 1 of the first model may be calculated based on the first loss, the second loss, the third loss, the fourth loss, and the corresponding weight, and then the parameter of the encoder 1 of the first model is adjusted based on the loss.

An overall replay training loss is as follows:

$${ℒ}_{replay} = {ℒ}_{C \_ cls} + {ℒ}_{l \_ cls} + {λ}_{1} {ℒ}_{C \_ fkd} + {λ}_{2} {ℒ}_{l \_ fkd}$$

λ₁ and λ₂ are hyper parameters, and values thereof may be user-defined, for example, may be respectively 0.5 and 0.7.

After a task T_{K} is learned, for each test sample

$${x}_{i}^{*} ,$$

a final first relation may be obtained by comparing a feature vector thereof with all adaptive relation prototypes, that is, second feature vectors of a first relation.

$${y}_{i}^{*} = arg {max}_{{y}_{i}^{*} ∈ {\hat{R}}^{k}} ( ( 1 - β ) {P}_{c} ( {x}_{i}^{*} ; {θ}_{k} ) + β {P}_{l} ( {x}_{i}^{*} ; {θ}_{k} ) )$$

$${P}_{c} ( {x}_{i}^{*} ; {θ}_{k} ) and {P}_{l} ( {x}_{i}^{*} ; {θ}_{k} )$$

are probabilities respectively calculated by using a contrastive learning method and a linear method, β is a hyper parameter, and β may be 0.4.

This disclosure recognizes the shortcoming of the k-means algorithm in selecting a typical sample. Density peak clustering is used to select a representative sample, and a dynamic relation prototype is designed to eliminate the problem of catastrophic memory forgetting of an old task of CRE. To resolve a problem of representation bias in memory samples caused by model overfitting, this disclosure proposes a memory augmentation method that generates pseudo samples using a generative large language model. This method reduces overfitting of the first model. In addition, because a pseudo sample generated by a large model does not participate in subsequent prototype calculation, purity of sample data in memory is ensured.

The following shows experimental results obtained by the applicant by performing experiments on this solution on different data sets.

TABLE 1
is an experimental result on a data set FewRel
FewRel

| Method | T1 | T2 | T3 | T4 | T5 | T6 | T7 | T8 | T9 | T10 |
|---|---|---|---|---|---|---|---|---|---|---|
| FA-EMR | 89.0 | 69.0 | 59.1 | 54.2 | 47.8 | 46.1 | 43.1 | 40.7 | 38.6 | 35.2 |
| EMAR | 88.5 | 73.2 | 66.6 | 63.8 | 55.8 | 54.3 | 52.9 | 50.9 | 48.8 | 46.3 |
| EMAR (BERT) | 98.8 | 89.1 | 89.5 | 85.7 | 83.6 | 84.8 | 79.3 | 80.0 | 77.1 | 73.8 |
| CML | 91.2 | 74.8 | 68.2 | 58.2 | 53.7 | 50.4 | 47.8 | 44.4 | 43.1 | 39.7 |
| RP-CRE | 97.9 | 92.7 | 91.6 | 89.2 | 88.4 | 86.8 | 85.1 | 84.1 | 82.2 | 81.5 |
| CRECL | 97.8 | 94.9 | 92.7 | 90.9 | 89.4 | 87.5 | 85.7 | 84.6 | 83.6 | 82.7 |
| CRL | 98.2 | 94.6 | 92.5 | 90.5 | 89.4 | 87.9 | 86.9 | 85.6 | 84.5 | 83.1 |
| KIP- | 98.4 | 93.5 | 92.0 | 91.2 | 90.0 | 88.2 | 86.9 | 85.6 | 84.1 | 82.5 |
| Framework | | | | | | | | | | |
| ICRE-DAS | 98.1 ± 0.6 | 95.8 ± 1.7 | 93.6 ± 2.1 | 91.9 ± 2.0 | 91.1 ± 1.5 | 89.4 ± 2.0 | 88.1 ± 1.5 | 86.9 ± 1.3 | 85.6 ± 0.8 | 84.2 ± 0.4 |
| Present | 98.2 ± 0.7 | 97.5 ± 0.4 | 96.3 ± 1.2 | 94.2 ± 1.7 | 92.6 ± 1.9 | 89.9 ± 1.3 | 88.5 ± 0.6 | 87.1 ± 1.0 | 86.4 ± 0.7 | 84.8 ± 1.2 |
| disclosure | | | | | | | | | | |

TABLE 2
is an experimental result on a data set TACRED
TACRED

| Method | T1 | T2 | T3 | T4 | T5 | T6 | T7 | T8 | T9 | T10 |
|---|---|---|---|---|---|---|---|---|---|---|
| FA-EMR | 47.5 | 40.1 | 38.3 | 29.9 | 24 | 27.3 | 26.9 | 25.8 | 22.9 | 19.8 |
| EMAR | 73.6 | 57.0 | 48.3 | 42.3 | 37.7 | 34.0 | 32.6 | 30.0 | 27.6 | 25.1 |
| EMAR (BERT) | 96.6 | 85.7 | 81 | 78.6 | 73.9 | 72.3 | 71.7 | 72.2 | 72.6 | 71.0 |
| CML | 57.2 | 51.4 | 41.3 | 39.3 | 35.9 | 28.9 | 27.3 | 26.9 | 24.8 | 23.4 |
| RP-CRE | 97.6 | 90.6 | 86.1 | 82.4 | 79.8 | 77.2 | 75.1 | 73.7 | 72.4 | 72.4 |
| CRECL | 96.6 | 93.1 | 89.7 | 87.8 | 85.6 | 84.3 | 83.6 | 81.4 | 79.3 | 78.5 |
| CRL | 97.7 | 93.2 | 89.8 | 84.7 | 84.1 | 81.3 | 80.2 | 79.1 | 79.0 | 78.0 |
| KIP- | 98.3 | 95.0 | 90.8 | 87.5 | 85.3 | 84.3 | 82.1 | 80.2 | 79.6 | 78.6 |
| Framework | | | | | | | | | | |
| ICRE-DAS | 97.7 ± 1.6 | 94.3 ± 2.9 | 92.3 ± 3.3 | 88.4 ± 3.7 | 86.6 ± 3.0 | 84.5 ± 2.1 | 82.2 ± 2.8 | 81.1 ± 1.6 | 80.1 ± 0.7 | 79.1 ± 1.1 |
| Present | 98.5 ± 0.3 | 95.5 ± 0.4 | 93.3 ± 1.2 | 90.2 ± 2.7 | 89.3 ± 2.3 | 87.2 ± 1.7 | 84.1 ± 3.6 | 83.1 ± 1.9 | 81.7 ± 1.3 | 79.9 ± 1.4 |
| disclosure | | | | | | | | | | |

Specific impact of each component on model performance can be observed by means of ablation experiments on data sets FewRel and TACRED. These experimental results emphasize importance of parts in the provided method and key roles played by the parts in improving accuracy and efficiency of a continuous relation extraction task.

TABLE 3
is an ablation experimental result on data sets FewRel and TACRED

| | | | | | | | | | | |
|---|---|---|---|---|---|---|---|---|---|---|
| Method | T1 | T2 | T3 | T4 | T5 | T6 | T7 | T8 | T9 | T10 |

FewRel

| | | | | | | | | | | |
|---|---|---|---|---|---|---|---|---|---|---|
| Present | 98.2 | 97.5 | 96.3 | 94.2 | 92.6 | 89.9 | 88.5 | 87.1 | 86.4 | 84.8 |
| disclosure | | | | | | | | | | |
| w/o DC | 98.1 | 94.5 | 92.5 | 89.9 | 88.3 | 87.4 | 86.4 | 84.5 | 84.0 | 83.1 |
| w/o DRP | 98.2 | 95.8 | 94.7 | 92.3 | 90.1 | 89.3 | 87.4 | 86.2 | 85.7 | 83.6 |
| w/o LLM | 98.2 | 94.6 | 92.6 | 90.7 | 89.9 | 88.5 | 87.4 | 86.2 | 84.8 | 83.6 |

TACRED

| | | | | | | | | | | |
|---|---|---|---|---|---|---|---|---|---|---|
| Present | 98.5 | 95.5 | 93.3 | 90.2 | 89.3 | 87.2 | 84.1 | 83.1 | 81.7 | 79.9 |
| disclosure | | | | | | | | | | |
| w/o DC | 97.1 | 94.1 | 86.3 | 85.6 | 84.7 | 83.1 | 81.2 | 80.1 | 79.7 | 78.8 |
| w/o DRP | 98.5 | 95.0 | 92.1 | 89.7 | 87.9 | 85.6 | 83.1 | 82.9 | 80.6 | 79.8 |
| w/o LLM | 97.8 | 94.1 | 90.9 | 86.8 | 85.6 | 83.9 | 81.6 | 80.4 | 80.2 | 79.4 |

Advantages of the first model in this aspect of this disclosure are intuitively described by using the foregoing case study. The applicant selects 10 relations related to three highly similar groups, that is, [(0) director, (1) scriptwriter], [(2) country of origin, (3) location, (4) place of formation, (5) headquarters], and [(6) channel entrance, (7) tributary, (8) located in or beside a body of water, and (9) intersection]. FIG. 8 describes visualization results of a cosine similarity between relation prototypes of these 10 relations. It can be seen from the figure that semantically similar relations (such as “channel entrance” and “tributary”) have relatively similar relation prototypes, which reflects that our model learns a proper representation space. In addition, it can also be seen that a distinction between similar relation prototypes (such as “director” and “scriptwriter”) is still very obvious, which indicates that our model can distinguish analogous relations.

In this aspect of this disclosure, a representative second training sample is selected by using a local density and a distance parameter, and a problem of catastrophic memory forgetting of an old task is reduced by designing a dynamic relation prototype. For problems of highly similar relations and overfitting, generation of a memory sample based on a large model and focal knowledge distillation are used to prevent overfitting of model replay and distinction of highly similar relations. This disclosure is also designed to use an intra-class relative similarity merging loss to maintain an intra-class similarity state.

In addition, common pseudo samples of a relation r are obtained by using a large model. Execution of this augmentation strategy on all old tasks alleviates an overfitting problem of the model. In addition, these pseudo samples are only used for continuous training of the model, and do not participate in calculation of a relation prototype. Purity of sample data is ensured.

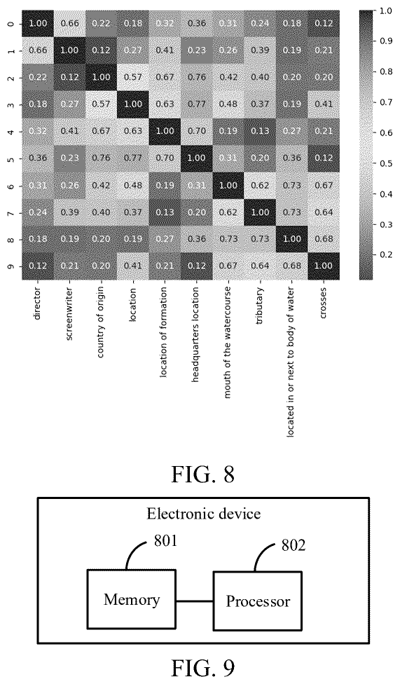

For ease of understanding the solution of this aspect, an electronic device is further provided. The electronic device may specifically implement the method of this aspect. Types of the electronic device may include a server, a terminal, or the like, which is not limited in this example. As shown in FIG. 9, the electronic device in this aspect may include a memory 801 and a processor 802.

The memory 801, such as non-transitory computer readable medium, may store data such as models and required samples and feature vectors in this disclosure, and may further store an application program that is invoked by the processor to perform steps of the model training method in this disclosure.

Processing circuitry, such as the processor 802 in this disclosure may run the application program in the memory to invoke the first model to perform feature extraction on a plurality of entity words in a first training sample by using a first model, to obtain first feature vectors of the entity words, the first training sample including at least a part of training samples for pre-training the first model, and the plurality of entity words of the first training sample having a first relation; perform relation classification on the entity words based on the first feature vectors, to obtain a first classification probability of the first training sample; determine sample-relation pairs separately formed by each first training sample and a plurality of second relations, the second relation including at least a part of first relations corresponding to the training samples for pre-training the first model; perform similarity calculation on the first feature vectors of the entity words of the first training sample in the sample-relation pair and a second feature vector of the second relation, to obtain a similarity corresponding to the sample-relation pair; determine a first weight of the sample-relation pair based on the similarity corresponding to the sample-relation pair, the first classification probability of the first training sample in the sample-relation pair, and the first relation; and determine a first loss of the first model based on the first weight of the sample-relation pair and the first classification probability of the first training sample in the sample-relation pair, and adjust a parameter of the first model based on the first loss.

The first training sample may be stored in the memory 801, or a training sample for pre-training the first model in the first training sample is stored in the memory 801.

In this aspect, the processor 802 assigns a first weight to a sample-relation pair to calculate a loss, to adjust a model parameter, so that a model can quickly pay more attention to similar relations, thereby improving distinguishing between similar relations by the model. In related technologies, similar problems are usually resolved by setting more samples of similar relations, increasing the quantity of times of training, and the like. Clearly, this manner increases the quantity of training samples, and the quantity of times of iteration of the model, consumes more storage resources and calculation resources of the processor, and even an increase in the quantity of times of iteration leads to worsening of forgetting of old relations by the model. When distinguishing between similar relations by the model is improved, forgetting of old knowledge by the model is increased. In the method for training a model by a processor in this disclosure, a sample-relation pair is constructed and a weight is assigned to the sample-relation pair to calculate the model loss, so that distinguishing between similar relations by the model can be improved without increasing a sample calculation amount of the processor, thereby effectively saving processing calculation resources. In addition, training samples of similar relations do not need to be massively set for distinguishing between the similar relations, and storage resources of a memory are further saved.

The processor may calculate a similarity parameter corresponding to the first training sample based on a similarity between a plurality of sample-relation pairs including the same first training sample; determine, for each sample-relation pair, a weight coefficient of the sample-relation pair based on the similarity parameter of the first training sample in the sample-relation pair and a similarity corresponding to the sample-relation pair; and determine a first weight of the sample-relation pair based on the weight coefficient of the sample-relation pair, the first classification probability of the first training sample in the sample-relation pair, and the first relation.

The processor may determine the first weight of the sample-relation pair based on a weight coefficient of the sample-relation pair and a first probability in the first classification probability; where the first probability is a probability that the first training sample in the sample-relation pair is a corresponding first relation.

The training samples for pre-training the first model include training samples for pre-training a first task and a second task of the first model, the second task precedes the first task, and the second relation includes a first relation of a training sample of a second task previous to the first task.

After the first model is pre-trained for each task, at least some training samples that may be used as first training samples may be selected from the task and stored in the memory. Other unselected training samples may be deleted, thereby reducing storage resource consumption of the memory.

The processor may obtain, from a second classification probability of a first training sample, a second probability that the first training sample in the sample-relation pair is a second relation in the sample-relation pair, the second classification probability being obtained by classifying the first training sample by using a second model, and the second model being obtained through training based on a part of training samples for pre-training the first model; multiply the first weight corresponding to the sample-relation pair by the second probability, to obtain a second weight corresponding to the sample-relation pair; and determine the first loss of the first model based on the second weight of the sample-relation pair and a third probability in the first classification probability, the third probability being a probability that the first training sample in the sample-relation pair is the second relation in the sample-relation pair.

The processor may classify relations of the entity words based on the first feature vectors by using a first classification network, to obtain the first classification probability of the first training sample; perform feature extraction on the entity words in the first training sample by using a first feature extraction network of the second model, to obtain third feature vectors of the entity words; and classify the relations of the entity words based on the third feature vectors by using a second classification network of the second model, to obtain a second classification probability of the first training sample, the second classification network having a same structure as the first classification network.

In this aspect, the first classification network and the second model may both be stored in the memory, to be invoked by the processor when needed.

The processor may calculate a second loss of the first model based on the first classification probability of the first training sample and the first relation; and adjust the parameter of the first model based on the first loss and the second loss.

The parameter of the first model is jointly adjusted by using a plurality of types of losses, so that a training speed of the first model can be accelerated, helping to increase a convergence speed of the first model, so that when training of the model consumes same processor resources and memory resources, the model can learn more knowledge, thereby improving benefits of the processor resources and the memory resources.

The processor may map the first feature vector by using a third classification network, to obtain a fourth feature vector; classify a relation between the entity words in the first training sample based on the fourth feature vector by using the third classification network, to obtain the first classification probability of the first training sample; perform feature extraction on the entity words in the first training sample by using a second feature extraction network of the second model, to obtain fifth feature vectors of the entity words; and classify the relations of the entity words based on the fifth feature vectors by using a fourth classification network of the second model, to obtain a second classification probability of the first training sample, the fourth classification network having a same structure as the third classification network.

In this aspect, the third classification network is stored in the memory, to be invoked by the processor when needed. The processor provides another implementation solution of the second classification probability by invoking the third classification network.

The processor may determine a relation set of the first training sample, the relation set including a first relation corresponding to each first training sample; determine, for each first training sample, a third loss of the first model according to a second feature vector of the first relation corresponding to the first training sample, a second feature vector of each first relation in the relation set, and the fourth feature vector of the first training sample; determine, for each first training sample, a third relation corresponding to the first training sample in the relation set, a feature vector similarity between the third relation and the first relation corresponding to a same first training sample meeting a preset similarity condition; determine a fourth loss of the first model based on the fourth feature vector of the first training sample and second feature vectors of the first relation and the third relation of the first training sample; and adjust the parameter of the first model based on the first loss, the third loss, and the fourth loss.

The first relation set may be stored in the memory. The processor adjusts the parameter of the first model by using a plurality of losses, to facilitate fast convergence of the model and increase a yield rate of resource consumption.

The processor may calculate a first dot product of the fourth feature vector of the first training sample and the second feature vector of the first relation of the first training sample; calculate a second dot product of the fourth feature vector of the first training sample and the second feature vector of each first relation in the relation set; and determine the third loss of the first model based on the first dot product and the second dot product.

The processor may calculate a third dot product of the fourth feature vector of the first training sample and the second feature vector of the first relation of the first training sample; calculate a fourth dot product of the fourth feature vector of the first training sample and the second feature vector of the third relation of the first training sample; and determine the fourth loss of the first model based on a difference between the fourth dot product and the third dot product.

Before performing similarity calculation on the first feature vectors of the entity words of the first training sample in the sample-relation pair and a second feature vector of the second relation, to obtain a similarity corresponding to the sample-relation pair, the processor may calculate, for each first relation, a sixth feature vector of the first relation based on a first feature vector of an entity word in a first training sample corresponding to the first relation; obtain a seventh feature vector of the first relation, the seventh feature vector being obtained by classifying a training sample corresponding to the first relation by using a first model pre-trained by the training sample corresponding to the first relation; and determine a second feature vector of the first relation based on the sixth feature vector and the seventh feature vector of the first relation.

After the first model is pre-trained each time, based on a training sample used in the pre-training and the pre-trained first model, the seventh feature vector of each first relation corresponding to the training sample is extracted and stored in the memory. It can be learned by referring to the description of the foregoing aspect that, the sixth feature vector is a dynamic prototype component of a relation, and does not need to be always stored in the memory, which can reduce resource consumption of the memory.

The processor may obtain a second training sample, the second training sample including a part of training samples for pre-training the first model; perform sample generation processing based on a first relation corresponding to the second training sample, to obtain a third training sample corresponding to the first relation, entity words in the third training sample having the first relation; and obtain the first training sample of the first model based on the second training sample and the third training sample.

In this disclosure, by using the model generation manner, when the model training method needs to be performed on the first model, the third training sample is obtained. This can improve richness of the first training sample and reduce time and resource consumption for the memory to store the third training sample.

The processor may calculate, for training samples that correspond to a same first relation and that are in the first task, a local density and a distance parameter of each training sample, the distance parameter being used for indicating a distance between the training sample and another training sample that corresponds to the same first relation; select, based on the local densities and the distance parameters of the training samples corresponding to the same first relation, a second training sample corresponding to the first relation from the training samples; and obtain a second training sample corresponding to each first relation in the second task.

The processor selects the second training sample according to the local density and the distance parameter, so that representativeness of the second training sample in the first training sample can be improved. Compared with a representative sample selection solution in the related technology, a quantity of second training samples selected by the processor can be relatively reduced. Therefore, a storage resource for storing a representative sample by the memory can be effectively reduced.

The processor may calculate, for each first relation, a sixth feature vector corresponding to the first relation based on a first feature vector corresponding to an entity word in a second training sample in the first training sample.

The processor may obtain a third weight corresponding to the sixth feature vector and a fourth weight corresponding to the seventh feature vector; and perform, for a same first relation, weighted summation based on the sixth feature vector of the first relation, the third weight, the seventh feature vector, and the fourth weight, to obtain the second feature vector of the first relation.

According to this disclosure, the processor constructs a sample-relation pair and assigns a weight to the sample-relation pair to calculate the model loss, so that distinguishing between similar relations by the model can be improved without increasing a sample calculation amount of the processor, thereby effectively saving processing calculation resources. In addition, training samples of similar relations do not need to be massively set for distinguishing between the similar relations, and storage resources of a memory are further saved.

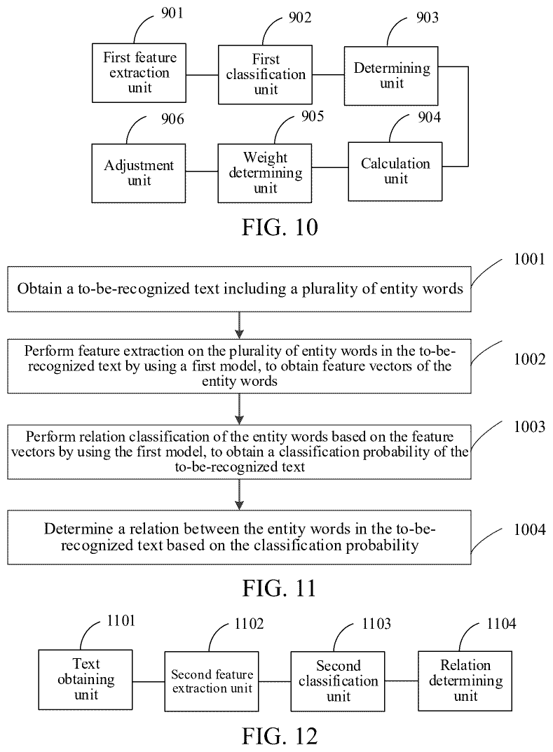

An aspect further provides a model training apparatus. The model training apparatus may be specifically integrated into an electronic device. For example, as shown in FIG. 10, the model training apparatus may include:
a first feature extraction unit 901, configured to perform feature extraction on a plurality of entity words in a first training sample by using a first model, to obtain first feature vectors of the entity words, the first training sample including at least a part of training samples for pre-training the first model, and the plurality of entity words of the first training sample having a first relation;
a first classification unit 902, configured to perform relation classification on the entity words based on the first feature vectors, to obtain a first classification probability of the first training sample;
a determining unit 903, configured to determine sample-relation pairs separately formed by each first training sample and a plurality of second relations, the second relation including at least a part of first relations corresponding to the training samples for pre-training the first model;
a calculation unit 904, configured to perform similarity calculation on the first feature vectors of the entity words of the first training sample in the sample-relation pair and a second feature vector of the second relation, to obtain a similarity corresponding to the sample-relation pair;
a weight determining unit 905, configured to determine a first weight of the sample-relation pair based on the similarity corresponding to the sample-relation pair, the first classification probability of the first training sample in the sample-relation pair, and the first relation; and
an adjustment unit 906, configured to determine a first loss of the first model based on the first weight of the sample-relation pair and the first classification probability of the first training sample in the sample-relation pair, and adjust a parameter of the first model based on the first loss.

In an aspect, the weight determining unit is configured to:
calculate a similarity parameter corresponding to the first training sample based on a similarity between a plurality of sample-relation pairs including the same first training sample;
determine, for each sample-relation pair, a weight coefficient of the sample-relation pair based on the similarity parameter of the first training sample in the sample-relation pair and a similarity corresponding to the sample-relation pair; and
determine a first weight of the sample-relation pair based on the weight coefficient of the sample-relation pair, the first classification probability of the first training sample in the sample-relation pair, and the first relation.

In an aspect, the weight determining unit is configured to determine a first weight of the sample-relation pair based on the weight coefficient of the sample-relation pair and a first probability that is in the first classification probability and that is of the first training sample in the sample-relation pair. The first probability is a probability that the first training sample is classified into a corresponding first relation.

In an aspect, the training samples for pre-training the first model include training samples for pre-training a first task and a second task of the first model, the second task precedes the first task, and the second relation includes a first relation of a training sample of a second task previous to the first task.

In an aspect, the adjustment unit is configured to:
obtain, from a second classification probability of a first training sample, a second probability that the first training sample in the sample-relation pair is a second relation in the sample-relation pair, the second classification probability being obtained by classifying the first training sample by using a second model, and the second model being obtained through training based on a part of training samples for pre-training the first model;
multiply the first weight corresponding to the sample-relation pair by the second probability, to obtain a second weight corresponding to the sample-relation pair; and
determine the first loss of the first model based on the second weight of the sample-relation pair and a third probability that is in the first classification probability and that is of the first training sample in the sample-relation pair, the third probability being a probability that the first training sample is the second relation in the sample-relation pair.

In an aspect, the first classification unit is configured to:
classify relations of the entity words based on the first feature vectors by using a first classification network, to obtain the first classification probability of the first training sample; and
the apparatus further includes: a first auxiliary unit, configured to:
perform feature extraction on the entity words in the first training sample by using a first feature extraction network of the second model, to obtain third feature vectors of the entity words; and
classify the relations of the entity words based on the third feature vectors by using a second classification network of the second model, to obtain a second classification probability of the first training sample, the second classification network having a same structure as the first classification network.

In an aspect, the model training apparatus further includes: a first loss calculation unit, configured to calculate a second loss of the first model based on the first classification probability of the first training sample and the first relation; and
an adjustment unit, configured to adjust the parameter of the first model based on the first loss and the second loss.

In an aspect, the first classification unit is configured to:
map the first feature vector by using a third classification network, to obtain a fourth feature vector; and
classify a relation between the entity words in the first training sample based on the fourth feature vector by using the third classification network, to obtain the first classification probability of the first training sample; and
the apparatus further includes: a second auxiliary unit, configured to:
perform feature extraction on the entity words in the first training sample by using a second feature extraction network of the second model, to obtain fifth feature vectors of the entity words; and
classify the relations of the entity words based on the fifth feature vectors by using a fourth classification network of the second model, to obtain a second classification probability of the first training sample, the fourth classification network having a same structure as the third classification network.

In an aspect, the apparatus further includes: a second loss calculation unit, configured to:
determine a relation set of the first training sample, the relation set including a first relation corresponding to each first training sample;
determine, for each first training sample, a third loss of the first model according to a second feature vector of the first relation corresponding to the first training sample, a second feature vector of each first relation in the relation set, and the fourth feature vector of the first training sample;
determine, for each first training sample, a third relation corresponding to the first training sample in the relation set, a feature vector similarity between the third relation and the first relation corresponding to a same first training sample meeting a preset similarity condition; and
determine a fourth loss of the first model based on the fourth feature vector of the first training sample and second feature vectors of the first relation and the third relation of the first training sample; and
an adjustment unit, configured to adjust the parameter of the first model based on the first loss, the third loss, and the fourth loss.

In an aspect, the second loss calculation unit is configured to:
calculate a first dot product of the fourth feature vector of the first training sample and the second feature vector of the first relation of the first training sample;
calculate a second dot product of the fourth feature vector of the first training sample and the second feature vector of each first relation in the relation set; and
determine the third loss of the first model based on the first dot product and the second dot product.

In an aspect, the second loss calculation unit is configured to:
calculate a third dot product of the fourth feature vector of the first training sample and the second feature vector of the first relation of the first training sample;
calculate a fourth dot product of the fourth feature vector of the first training sample and the second feature vector of the third relation of the first training sample; and
determine the fourth loss of the first model based on a difference between the fourth dot product and the third dot product.

In an aspect, the apparatus further includes: a vector calculation unit, configured to:
before performing similarity calculation on the first feature vectors of the entity words of the first training sample in the sample-relation pair and a second feature vector of the second relation, to obtain a similarity corresponding to the sample-relation pair, calculate, for each first relation, a sixth feature vector of the first relation based on a first feature vector of an entity word in a first training sample corresponding to the first relation;
obtain a seventh feature vector of the first relation, the seventh feature vector being obtained by classifying a training sample corresponding to the first relation by using a first model pre-trained by the training sample corresponding to the first relation; and
determine a second feature vector of the first relation based on the sixth feature vector and the seventh feature vector of the first relation.

In an aspect, the apparatus further includes: a training sample obtaining unit, configured to:
before performing feature extraction on a plurality of entity words in a first training sample by using a first model, to obtain first feature vectors of the entity words, obtain a second training sample, the second training sample including a part of training samples for pre-training the first model;
perform sample generation processing based on a first relation corresponding to the second training sample, to obtain a third training sample corresponding to the first relation, entity words in the third training sample having the first relation; and
obtain the first training sample of the first model based on the second training sample and the third training sample.

In an aspect, the training samples for pre-training the first model include a training sample for training a first task and a second task of the first model, the second task precedes the first task, and the training sample obtaining unit is configured to:
calculate, for training samples that correspond to a same first relation and that are in the first task, a local density and a distance parameter of each training sample, the distance parameter being used for indicating a distance between the training sample and another training sample that corresponds to the same first relation;
select, based on the local densities and the distance parameters of the training samples corresponding to the same first relation, a second training sample corresponding to the first relation from the training samples; and
obtain a second training sample corresponding to each first relation in the second task.

In an aspect, the vector calculation unit is configured to calculate, for each first relation, a sixth feature vector corresponding to the first relation based on a first feature vector corresponding to an entity word in a second training sample in the first training sample.

In an aspect, the vector calculation unit is configured to obtain a third weight corresponding to the sixth feature vector and a fourth weight corresponding to the seventh feature vector; and perform, for a same first relation, weighted summation based on the sixth feature vector of the first relation, the third weight, the seventh feature vector, and the fourth weight, to obtain the second feature vector of the first relation.

According to the model training apparatus of this aspect, after the first model is pre-trained, sample-relation pairs are formed by using the first training sample and a plurality of relations, and a weight is allocated to the sample-relation pair based on a classification probability of the first training sample and a similarity between feature vectors of the sample and the relation, to calculate the loss to adjust the model parameter, so that the model pays more attention to similar relations, thereby helping the model to distinguish between analogous relations.

An aspect of this disclosure further provides a classification method. In the classification method, entity words in a text are classified by using the first model trained by using the foregoing model training method, to obtain a relation between the entity words in the text. Referring to FIG. 11, the classification method may include:

Step 1001: Obtain a to-be-recognized text including a plurality of entity words.

The text may be directly obtained, or the text may be extracted from multimedia content such as an image or a video, to obtain the to-be-recognized text.

Step 1002: Perform feature extraction on the plurality of entity words in the to-be-recognized text by using a first model, to obtain feature vectors of the entity words.

Step 1003: Perform relation classification on the entity words based on the feature vectors by using the first model, to obtain a classification probability of the to-be-recognized text.

For specific solutions of steps 1002 and 1003, reference can be made to the foregoing aspects. Details are not described herein again.

It may be understood that, the first model has a classification function, and is a multi-classification model. A plurality of classification categories are configured at an output end thereof, and each classification category corresponds to one first relation.

Step 1004: Determine a relation between the entity words in the to-be-recognized text based on the classification probability.

The classification probability may include a probability that the to-be-recognized text is classified into a plurality of first relations. Step 1004 may be performed by the first model. That is, the first model determines the relation between the entity words in the to-be-recognized text based on probabilities corresponding to a plurality of first relations. For example, a first relation corresponding to a maximum probability is selected as the relation between the entity words in the to-be-recognized text.

Alternatively, in step 1004, the classification probability may be output to a discriminator, and the discriminator determines the relation between the entity words in the text according to the probabilities.

The first model in this disclosure is obtained through training based on the foregoing training solution, reserves much knowledge about first relations, can provide effective relation classification, and has a good distinguishing capability for similar relations. Therefore, identification accuracy of a relation between entity words in a text can be ensured.

Referring to FIG. 12, an aspect of this disclosure further provides a classification apparatus. The apparatus includes:
a text obtaining unit 1101, configured to obtain a to-be-recognized text including a plurality of entity words;
a second feature extraction unit 1102, configured to perform feature extraction on the plurality of entity words in the to-be-recognized text by using a first model, to obtain feature vectors of the entity words;
a second classification unit 1103, configured to perform relation classification on the entity words based on the feature vectors by using the first model, to obtain a classification probability of the to-be-recognized text; and
a relation determining unit 1104, configured to determine a relation between the entity words in the to-be-recognized text based on the classification probability.

In the classification apparatus, the first model may provide effective relation classification based on learned knowledge of first relations, and has a good distinguishing capability for similar relations. Therefore, identification accuracy of a relation between entity words in a text can be ensured.

An aspect of this disclosure further provides a computer device. The computer device may be a server or a terminal device. The computer device includes a memory and a processor. The memory stores a computer program. When executing the computer program, the processor implements the steps of the foregoing model training method or classification method, thereby implementing various functions, for example:
performing feature extraction on a plurality of entity words in a first training sample by using a first model, to obtain first feature vectors of the entity words, the first training sample including at least a part of training samples for pre-training the first model, and the plurality of entity words of the first training sample having a first relation;
performing relation classification on the entity words based on the first feature vectors, to obtain a first classification probability of the first training sample;
determining sample-relation pairs separately formed by each first training sample and a plurality of second relations, the second relation including at least a part of first relations corresponding to the training samples for pre-training the first model;
performing similarity calculation on the first feature vectors of the entity words of the first training sample in the sample-relation pair and a second feature vector of the second relation, to obtain a similarity corresponding to the sample-relation pair;
determining a first weight of the sample-relation pair based on the similarity corresponding to the sample-relation pair, the first classification probability of the first training sample in the sample-relation pair, and the first relation; and
determining a first loss of the first model based on the first weight of the sample-relation pair and the first classification probability of the first training sample in the sample-relation pair, and adjust a parameter of the first model based on the first loss;
or
obtaining a to-be-recognized text including a plurality of entity words;
performing feature extraction on the plurality of entity words in the to-be-recognized text by using a first model, to obtain feature vectors of the entity words;
performing relation classification on the entity words based on the feature vectors by using the first model, to obtain a classification probability of the to-be-recognized text; and
determining a relation between the entity words in the to-be-recognized text based on the classification probability.

Therefore, the first model may have a capability of distinguishing between highly similar relations, thereby ensuring accuracy of a classification probability.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

For specific implementations of the above operations, reference can be made to the foregoing aspects. Details are not described herein again.

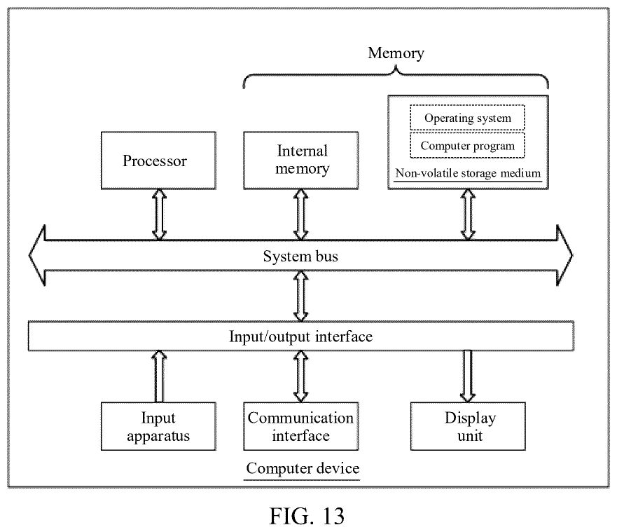

In an aspect, an example in which the computer device is a terminal device is used, and a diagram of an internal structure thereof may be shown in FIG. 13. The computer device includes a processor, a memory, an input/output interface, a communication interface, a display unit, and an input apparatus. The processor, the memory, and the input/output interface are connected to each other by using a system bus, and the communication interface, the display unit, and the input apparatus are connected to the system bus by using the input/output interface. The processor of the computer device is configured to provide a computing and control capability. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular network, a near field communication (NFC), or another technology. The computer program, when executed by the processor, implements a model training method. The display unit of the computer device is configured to form a visual picture, and may be a display screen, a projection apparatus, or a virtual reality imaging apparatus. The display screen may be a liquid crystal display screen or an electronic ink display screen. The input apparatus of the computer device may be a touch layer covering the display screen, may be a key, a trackball, or a touchpad disposed on a housing of the computer device, or may be an external keyboard, touchpad, or mouse.

A person skilled in the art may understand that the structure shown in FIG. 13 is merely a block diagram of a partial structure related to the solutions of this disclosure, and does not constitute a limitation on the computer device to which the solutions of this disclosure are applied. A specific computer device may include more or fewer components than those shown in the figure, or combine some components, or have different component arrangements.

An aspect of this disclosure further provides a computer readable storage medium, such as an non-transitory computer-readable storage medium. The computer readable storage medium may include: a read-only memory (ROM), a random access memory (RAM), a magnetic disk, an optical disc, or the like.

Because a computer program stored in the computer readable storage medium may execute any model training method provided in the aspects of this disclosure, beneficial effects that can be implemented by any model training method provided in the aspects of this disclosure may be implemented. For examples of details, reference can be made to the foregoing aspects, and details are not described herein again.

An aspect of this disclosure further provides a computer program product or a computer program. The computer program product or the computer program includes computer instructions, and the computer instructions are stored in a computer readable storage medium. A processor of a computer device reads the computer instructions from the computer readable storage medium, and the processor executes the computer instructions, so that the computer device performs the method in the foregoing aspects.

A person of ordinary skill in the art may understand that all or some of procedures of the method in the foregoing aspects may be implemented by a computer program instructing relevant hardware. The program may be stored in a non-volatile computer-readable storage medium. When the program is executed, the procedures of the foregoing methods may be performed.

Any reference to a memory, a database, or another medium used in the embodiments provided in this disclosure may include a non-transitory computer-readable storage medium, such as at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration but not a limitation, the RAM may be in a plurality of forms, such as a static random access memory (SRAM) or a dynamic random access memory (DRAM).

The database involved in the aspects provided in this disclosure may include at least one of a relational database and a non-relational database. The non-relational database may include a blockchain-based distributed database or the like, which is not limited thereto. The processor in the aspects provided in this disclosure may be a general purpose processor, a graphics processor, a digital signal processor, a programmable logic device, a quantum computing-based data processing logic device, or the like, which is not limited thereto.

In the foregoing model training apparatus, computer readable storage medium, computer device, and computer program product aspects, the descriptions of each aspect focus on different aspects. For parts not detailed in an example, references can be made to the relevant descriptions in other aspects. It may be clearly understood by a person skilled in the art that, for convenience and brevity of description, for a specific working process and beneficial effects of the model training apparatus, the classification apparatus, the computer readable storage medium, the computer program product, the computer device, and the corresponding units described above, references may be made to descriptions of the model training method in the foregoing aspects, and details are not described herein again.

Technical features of the foregoing aspects may be combined in various manners. To make description concise, not all possible combinations of the technical features in the foregoing aspects are described. However, the combinations of these technical features shall be considered as falling within the scope recorded by this specification provided that no conflict exists.

The foregoing describes in detail a model training method and apparatus, a classification method and apparatus, a computer device, a computer readable storage medium, and a computer program product that are provided in this disclosure. The foregoing examples are merely used to help understand aspects of the method. Other aspects are within the scope of this disclosure.

What is claimed is:

1. A model training method, the method comprising:
performing feature extraction on a plurality of words in a first training sample to obtain first feature vectors of the plurality of words, the first training sample including at least a first part of training samples for pre-training a first model, and the plurality of words of the first training sample having one or more first relations;
performing relation classification on the plurality of words based on the first feature vectors, to obtain a first classification probability of the first training sample;
determining a plurality of sample-relation pairs formed by the first training sample and each relation of a plurality of second relations, the second relations including at least a part of the one or more first relations;
performing similarity calculation on the first feature vectors of the plurality of words of the first training sample in the sample-relation pairs and second feature vectors of the plurality of second relations, to obtain similarities corresponding to the sample-relation pairs;
determining a first weight of a sample-relation pair of the plurality of sample-relation pairs based on the similarity corresponding to the sample-relation pair, the first classification probability of the first training sample, and the first relation;
determining a first loss of the first model based on the first weight of the sample-relation pair and the first classification probability; and
adjusting a parameter of the first model based on the first loss.

2. The model training method according to claim 1, wherein the determining the first weight of the sample-relation pair further comprises:
determining, for each sample-relation pair, a weight coefficient of the respective sample-relation pair based on the similarity corresponding to the respective sample-relation pair; and
determining the first weight of the sample-relation pair based on the weight coefficient, the first classification probability of the first training sample, and one of the one or more first relations.

3. The model training method according to claim 1, wherein the determining the first weight of the sample-relation pair further comprises:
determining the first weight of the sample-relation pair based on a weight coefficient of the sample-relation pair and a first probability in the first classification probability;
wherein the first probability corresponds to one of the one or more first relations.

4. The model training method according to claim 1, wherein the training samples for pre-training the first model comprises:
training samples for pre-training a first task of the first model and a second task of the first model, the second task preceding the first task, and the second relation including a first relation of a training sample of the second task that precedes to the first task.

5. The model training method according to claim 1, wherein the determining the first loss of the first model further comprises:
obtaining a second probability from a second classification probability of the first training sample, the second probability of the first training sample in the sample-relation pair being one of the plurality of second relations, the second classification probability being obtained from the first training sample via a second model, and the second model being obtained based on a second part of a plurality of training samples for pre-training the first model;
applying the first weight corresponding to the sample-relation pair to the second probability, to obtain a second weight corresponding to the sample-relation pair; and
determining the first loss of the first model based on the second weight of the sample-relation pair and a third probability in the first classification probability, the third probability indicating a probability of the first training sample in the sample-relation pair being one of the plurality of second relations.

6. The model training method according to claim 1, further comprising: performing feature extraction on the plurality of words in the first training sample by using a first feature extraction network of a second model, to obtain third feature vectors of the plurality of words; and
classifying the relations of the plurality of words based on the third feature vectors via a second classification network of the second model, to obtain a second classification probability of the first training sample, the second classification network having a same structure as the first classification network.

7. The model training method according to claim 6, wherein the method further comprises:
calculating a second loss of the first model based on the first classification probability of the first training sample and the one or more first relations; and
adjusting the parameter of the first model based on the first loss and the second loss.

8. The model training method according to claim 1, wherein the performing the relation classification on the plurality of words further comprises:
mapping the first feature vector by using a third classification network, to obtain fourth feature vectors; and
classifying the relations between the plurality of words in the first training sample based on the fourth feature vectors by using the third classification network, to obtain the first classification probability of the first training sample.

9. The model training method according to claim 8, wherein the method further comprises:
performing feature extraction on the plurality of words in the first training sample by using a second feature extraction network of the second model, to obtain fifth feature vectors of the plurality of words; and
classifying the plurality of words based on the fifth feature vectors by using a fourth classification network of the second model, to obtain a second classification probability of the first training sample, the fourth classification network having a same structure as the third classification network.

10. The model training method according to claim 9, wherein the adjusting the parameter of the first model based on the first loss further comprises:
determining a relation set of the first training sample, the relation set comprising a first relation corresponding to each first training sample;
determining, for each first training sample, a third loss of the first model according to second feature vectors of the one or more first relations corresponding to the first training sample, a second feature vector of each first relation in the relation set, and the fourth feature vector of the first training sample;
determining, for each first training sample, a third relation corresponding to the first training sample in the relation set, a feature vector similarity between the third relation and the first relation corresponding to a same first training sample meeting a preset similarity condition; and
determining a fourth loss of the first model based on the fourth feature vector of the first training sample and the second feature vectors of the one or more first relations and the third relation of the first training sample; and
adjusting the parameter of the first model based on the first loss, the third loss, and the fourth loss.

11. The model training method according to claim 10, wherein the determining the third loss of the first model further comprises:
calculating first dot products of the fourth feature vectors of the first training sample and the second feature vectors of the one or more first relations of the first training sample;
calculating second dot products of the fourth feature vectors of the first training sample and the second feature vectors of the one or more first relations in the relation set; and
determining the third loss of the first model based on the first dot products and the second dot products.

12. The model training method according to claim 10, wherein the determining the fourth loss of the first model further comprises:
calculating third dot products of the fourth feature vectors of the first training sample and the second feature vectors of the one or more first relations of the first training sample;
calculating fourth dot products of the fourth feature vectors of the first training sample and the second feature vectors of each of the third relation of the first training sample; and
determining the fourth loss of the first model based on a difference between the fourth dot products and the third dot products.

13. The model training method according to claim 1, wherein the method further comprises:
for each first relation,
calculating a sixth feature vector based on a first feature vector of an word in the first training sample corresponding to the respective first relation;
obtaining a seventh feature vector of the respective first relation, the seventh feature vector being obtained by classifying a training sample corresponding to the respective first relation by using a first model pre-trained by the training sample corresponding to the respective first relation; and
determining a second feature vector of the respective first relation based on the sixth feature vector and the seventh feature vector of the respective first relation.

14. The model training method according to claim 13, wherein the method further comprises:
obtaining a second training sample, the second training sample including a third part of the training samples for pre-training the first model;
performing sample generation processing based on a first relation corresponding to the second training sample, to obtain a third training sample corresponding to the first relation of the second training sample; and
obtaining the first training sample of the first model based on the second training sample and the third training sample.

15. The model training method according to claim 14, wherein the obtaining the second training sample further comprises:
calculating, for the training samples that correspond to a same first relation and that are in a first task, a local density and a distance parameter of each training sample, the distance parameters indicating distances between the training samples corresponding to the same first relation;
selecting, based on the local densities and the distance parameters of the training samples corresponding to the same first relation, the second training sample corresponding to the first relation from the training samples; and
obtaining the second training sample corresponding to the first relation in the second task.

16. The model training method according to claim 13, wherein the determining the second feature vector of the first relation further comprises:
obtaining a third weight corresponding to the sixth feature vector and a fourth weight corresponding to the seventh feature vector; and
performing, for the first relation, weighted summation based on the sixth feature vector of the first relation, the third weight, the seventh feature vector, and the fourth weight, to obtain the second feature vector of the first relation.

17. A model training apparatus, the apparatus comprising:
processing circuitry configured to
perform feature extraction on a plurality of words in a first training sample to obtain first feature vectors of the plurality of words, the first training sample including at least a first part of training samples for pre-training a first model, and the plurality of words of the first training sample have one or more first relations;
perform relation classification on the plurality of words based on the first feature vectors, to obtain a first classification probability of the first training sample;
determine a plurality of sample-relation pairs formed by the first training sample and each relation of a plurality of second relations, the second relations include at least a part of the one or more first relations;
perform similarity calculation on the first feature vectors of the plurality of words of the first training sample in the sample-relation pairs and a second feature vectors of the plurality of second relations, to obtain similarities corresponding to the sample-relation pairs;
determine a first weight of a sample-relation pair of the plurality of sample-relation pairs based on the similarity of the corresponding to the sample-relation pair, the first classification probability of the first training sample, and the first relation;
determine a first loss of the first model based on the first weight of the sample-relation pair and the first classification probability; and
adjust a parameter of the first model based on the first loss.

18. The apparatus according to claim 17, wherein the processing circuitry is configured to:
determine, for each sample-relation pair, a weight coefficient of the respective sample-relation pair based on the similarity corresponding to the respective sample-relation pair; and
determine the first weight of the sample-relation pair based on the weight coefficient, the first classification probability of the first training sample, and one of the one or more first relations.

19. A non-transitory computer-readable storage medium, storing instructions which when executed by a processor cause the processor to perform:
extracting feature on a plurality of words in a first training sample to obtain first feature vectors of the plurality of words, the first training sample including at least a first part of training samples for pre-training a first model, and the plurality of words of the first training sample having one or more first relations;
classifying relation on the plurality of words based on the first feature vectors, to obtain a first classification probability of the first training sample;
determining a plurality of sample-relation pairs formed by the first training sample and each relation of a plurality of second relations, the second relations including at least a part of the one or more first relations;
calculating similarity on the first feature vectors of the plurality of words of the first training sample in the sample-relation pairs and a second feature vectors of the plurality of second relations, to obtain similarities corresponding to the sample-relation pairs;
determining a first weight of a sample-relation pair of the plurality of sample-relation pairs based on the similarity corresponding to of the sample-relation pair, the first classification probability of the first training sample, and the first relation;
determining a first loss of the first model based on the first weight of the sample-relation pair and the first classification probability; and
adjusting a parameter of the first model based on the first loss.

20. The non-transitory computer-readable storage medium according to claim 19, wherein the determining the first weight of the sample-relation pair further comprises:
determining, for each sample-relation pair, a weight coefficient of the respective sample-relation pair based on the similarity corresponding to the respective sample-relation pair; and
determining the first weight of the sample-relation pair based on the weight coefficient, the first classification probability of the first training sample, and one of the one or more first relations.
